(19) United States
(12) Patent Application Publication
(10) Pub. No.: US 2012/0328169 A1
(43) Pub. Date: Dec. 27, 2012

(54) SYSTEM AND METHOD FOR YEARBOOK CREATION

(75) Inventors: MICHAEL HEETER, BLOOMINGTON, MN (US); ANDREA DAILEY, ST. PAUL, MN (US); BENJAMIN DEKARSKE, EDINA, MN (US)

(73) Assignee: JOSTENS, INC., MINNEAPOLIS, MN (US)

(21) Appl. No.: 13/535,927

(22) Filed: Jun. 28, 2012

Related U.S. Application Data
(63) Continuation-in-part of application No. 13/361,821, filed on Jan. 30, 2012.
Application No. 13/361,821 is a continuation-in-part of application No. 13/361,841, filed on Jan. 30, 2012.
(60) Provisional application No. 61/504,516, filed on Jul. 5, 2011.
(60) Provisional application No. 61/592,455, filed on Jan. 30, 2012.
(60) Provisional application No. 61/438,103, filed on Jan. 31, 2011.

(51) Int. Cl. G06K 9/00

(52) U.S. Cl. 382/118

(57) ABSTRACT

A method for creating a yearbook may include receiving a plurality of photos via upload to a website, receiving identifying information for subjects in each of the plurality of photos, associating the identifying information with each of the plurality of photos, receiving another photo, comparing the photo to the plurality of photos using a facial recognition module, and identifying a subject of the another photo with the facial recognition module.

### CROSS-REFERENCE TO RELATED APPLICATIONS

This application claims priority to U.S. Provisional Application 61/438,103 filed on Jan. 31, 2011 entitled System and Method for Yearbook Creation, U.S. Provisional Application 61/504,516 filed on Jul. 5, 2011 entitled System and Method for Yearbook Creation, U.S. Provisional Application 61/592,455 filed Jan. 30, 2012 entitled Facial Recognition System, U.S. Non-Provisional Application 13/361,821 filed Jan. 30, 2012 entitled System and Method for Yearbook Creation, and U.S. Non-Provisional Application 13/361,841 filed Jan. 30, 2012 entitled System and Method for Yearbook Creation, the contents of each of which are hereby incorporated by reference herein in their entireties.

### FIELD OF THE INVENTION

This invention relates generally to a system and method for creating yearbooks, and more specifically to an online system and method for creating yearbooks.

### BACKGROUND OF THE INVENTION

Yearbooks are currently developed using traditional desktop publishing applications such as PageMaker, Quark and InDesign. Traditional creation includes using paste-ups in a process that is typically very time-consuming.

### BRIEF SUMMARY OF THE INVENTION

The present invention relates to a system and method for creating yearbooks. The yearbook system provides a single, extensive resource to plan, create, educate about, sell, and distribute yearbooks. The system further provides an integrated yearbook system management and yearbook production system to enable the production of the yearbook to a printed output.

The yearbook system comprises a user component and a production component. The user component is used by the user to design and create the yearbook. The user component may include user-specific content and informational content. The production component is used to convert the created yearbook into a printed output. The user component and the production component interact such that submissions are made to the production component via the user component and the production component can communicate with the user component regarding the submissions.

The method for creating a yearbook comprises user planning of the yearbook, user development of the yearbook and user submission of completed portions of the yearbook. The method further comprises production review of the submitted portions of the yearbook, production communication to a user regarding the submission portions of the yearbook and production conversion of the submitted portions of the yearbook into a printed output.

In one embodiment, a yearbook system may include a user component through which a user may design and create a yearbook. The user component may include a facial recognition module for identifying a subject in a photo and tagging the photo with an identity of the subject. Identifying the subject may include comparing the photo to a plurality of previously tagged photos to identify the subject. In some embodiments, the system may include a photo submission website and the facial recognition module may perform the identifying operation upon upload of the photo to the photo submission website. In some embodiments, identifying a subject may include one or more of geometric and photometric processes. In another embodiment, the plurality of previously tagged photos includes at least three previously tagged photos of the subject. In other embodiments, the facial recognition module is further configured for prompting a user with a facial suggestion. In some embodiments, the suggestion may include displaying a comparable image of the subject and may also include prompting the user to confirm or deny the identity and may also include prompting the user to manually enter a tag. In some embodiments, prompting the user with a facial suggestion includes displaying a list of names and highlighting a name in the list of names. In still other embodiments, the list of names is a coverage report.

In another embodiment, a method for creating a yearbook may include receiving a plurality of photos via upload to a website, receiving identifying information for subjects in each of the plurality of photos, and associating the identifying information with each of the plurality of photos. In some embodiments, the method may also include receiving another photo, comparing the photo to the plurality of photos using a facial recognition module, and identifying a subject of the anther photo with the facial recognition module.

While multiple embodiments are disclosed, still other embodiments of the present teachings will become apparent to those skilled in the art from the following detailed description, which shows and described illustrative embodiments. As will be realized, the teachings are capable of modifications in various obvious aspects, all without departing from the spirit and scope of the present teachings. Accordingly, the drawings and detailed description are to be regarded as illustrative in nature and not restrictive.

### BRIEF DESCRIPTION OF THE DRAWINGS

FIG. 1 illustrates interaction of a yearbook system in accordance with one embodiment of the present invention.

FIG. 2 illustrates a flowchart of the user side of a yearbook process in accordance with one embodiment of the present invention.

FIG. 3 illustrates a yearbook system home page in accordance with one embodiment of the present invention.

FIG. 4 illustrates a planning ladder in accordance with one embodiment of the present invention.

FIG. 5 illustrates a fonts page in accordance with one embodiment of the present invention.

FIG. 6 illustrates a styles page in accordance with one embodiment of the present invention.

FIG. 7 illustrates a photo submission website page in accordance with one embodiment of the present invention.

FIG. 8 illustrates a yearbook staff maintenance screen in accordance with one embodiment of the present invention.

FIG. 9 illustrates a school information page in accordance with one embodiment of the present invention.

FIG. 10 illustrates a yearbook configuration information and key dates page in accordance with one embodiment of the present invention.

FIG. 11 illustrates a yearbook system calendar page in accordance with one embodiment of the present invention.

FIG. 12 illustrates a virtual book of a yearbook being created with a yearbook system in accordance with one embodiment of the present invention.

FIG. 13 illustrates a build ladder in accordance with one embodiment of the present invention.

FIG. 14 illustrates a printable ladder accordance with one embodiment of the present invention.

FIG. 15 illustrates a page preview screen in accordance with one embodiment of the present invention.

FIG. 16 illustrates a template builder page in accordance with one embodiment of the present invention.

FIG. 17 illustrates a portrait page template in accordance with one embodiment of the present invention.

FIG. 18 illustrates an activity page template in accordance with one embodiment of the present invention.

FIG. 19 illustrates a cover template in accordance with one embodiment of the present invention.

FIG. 20 illustrates a panel pages screen in accordance with one embodiment of the present invention.

FIG. 21 illustrates a portrait page editing screen in accordance with one embodiment of the present invention.

FIG. 22 illustrates an image library page in accordance with one embodiment of the present invention.

FIG. 23 illustrates a photo submissions information page in accordance with one embodiment of the present invention.

FIG. 24A illustrates a cover information page in accordance with one embodiment of the present invention.

FIG. 24B illustrates a messages page in accordance with one embodiment of the present invention.

FIG. 25 illustrates a process flow of a staff member customizing a page in accordance with one embodiment of the present invention.

FIG. 26 illustrates a page status grid in accordance with one embodiment of the present invention.

FIG. 27 illustrates a summary report in accordance with one embodiment of the present invention.

FIG. 28 illustrates a HOME flyer page in accordance with one embodiment of the present invention.

FIG. 29 illustrates a HOME web sales page in accordance with one embodiment of the present invention.

FIG. 30 illustrates a contact information page in accordance with one embodiment of the present invention.

FIG. 31 illustrates the flow of communication between yearbook staff, a yearbook system management, and a production facility in accordance with one embodiment of the present invention.

FIG. 32 illustrates a block diagram of the components of a yearbook system in accordance with one embodiment of the present invention.

FIG. 33 illustrates a block diagram of creating a yearbook in accordance with one embodiment of the present invention.

FIG. 34 illustrates a process of creating a yearbook using the components of a yearbook system in accordance with one embodiment of the present invention.

FIG. 35 illustrates a process for pre-press scanning of images in accordance with one embodiment of the present invention.

FIG. 36 illustrates several operations for using facial recognition to keep track of the coverage of individuals appearing in a yearbook according to some embodiments.

FIG. 37 illustrates an example of an interface for presenting a user with suggested matches of a facial recognition analysis according to some embodiments.

### DETAILED DESCRIPTION OF THE INVENTION

The present invention relates to a yearbook system to plan, create, educate about, sell, and distribute yearbooks. The yearbook system provides a single extensive resource for schools to design, create, sell and distribute yearbooks. The system further provides an integrated yearbook system management and yearbook production system to enable the production of the yearbook to a printed output. In some embodiments, the system facilitates contributions to the yearbook by community members outside of yearbook staff, such as parents of students appearing in the yearbook.

Of course, in addition to creating yearbooks such as those typically distributed in high schools and some middle schools, the present invention may be used to create memory books such as those distributed at elementary schools and small middle schools or other books. Yearbooks generally are hard cover, have 50 to several hundred pages (page range may vary), include endsheets and tip-ins, and may be produced in color or in black and white. Memory books generally are often soft cover, have 8-64 pages (page range may vary), and may be produced in color or in black and white. Generally, the present invention may be applied to any collaborative creation process—for books or other output. Thus, while the present invention is generally described in terms of yearbooks, the invention is equally suited for other books.

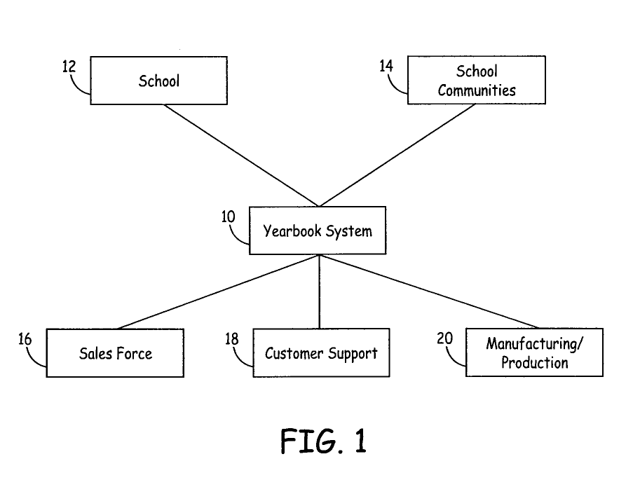

As shown in FIG. 1, the system 10 interacts with schools 12, school communities 14, a sales force 16, customer support 18, and manufacturing 20. Schools 12 may interact with the system 10 while designing a yearbook using a desk top publishing application or an online creation tool. Unless specified otherwise, the description of the system 10 is intended to encompass schools using a desk top publishing application as well as schools using an online creation tool. In some embodiments, the system 10 may be coordinated with a desk top publishing application such that a school can begin creation of a yearbook in a traditional manner, submit the created yearbook to production, and the created yearbook may be displayed online by the system.

### School Use of the Yearbook System

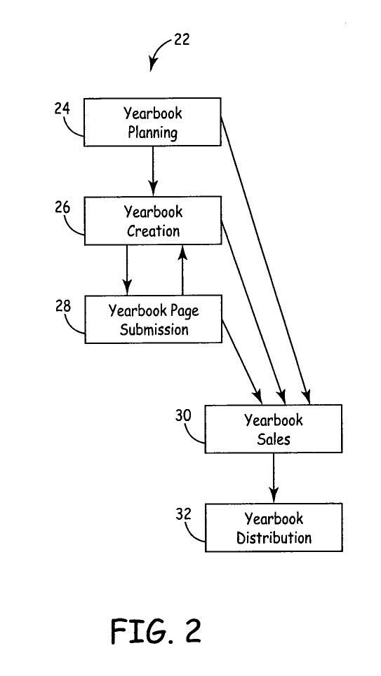

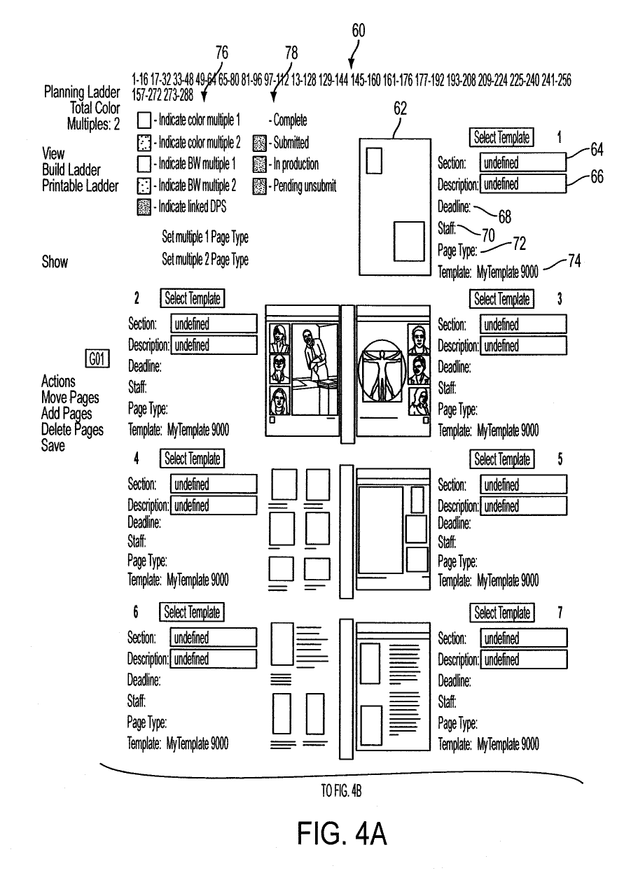

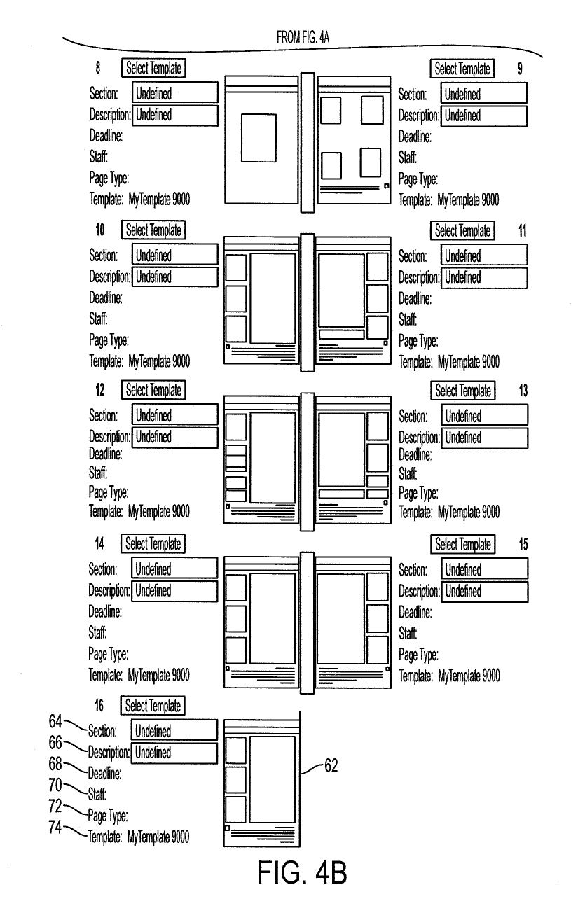

The yearbook system of the present invention provides a tool for use from the start to the finish of the yearbook process. Thus, the yearbook system, in addition to use in creating a yearbook, may be used for managing staff, educating staff regarding the yearbook process, merchandising, selling, and distributing the yearbook. In some embodiments, the yearbook system further permits contribution by people other than the yearbook staff. FIG. 2 illustrates a process flow 22 of a school using the yearbook system during the yearbook process. Prior to creating the yearbook, yearbook staff plan each portion of the yearbook 24—including cover, portrait pages, and activity pages. Planning may be accomplished by determining the sections to be included in the yearbook, determining what pages are to be devoted to which sections, choosing a template for each page, and assigning a staff member to each page. These planning selections may be incorporated into an easy-to-use planning ladder, described more fully below in relation to FIG. 4.

The yearbook system may include email functionality such that yearbook staff may email from the yearbook system instead of (or in addition to) personal email addresses. This functionality may be referred to as YBA email. The YBA email may be embedded in the yearbook system and linked to other components of the yearbook system. In some embodiments, an email can be sent through yearbook avenue to consumers with email address promoting recognition ads, yearbooks and/or replay it, for example. In some embodiments, as is discussed below, an email can be sent to consumers based on data in the coverage report including, consumers that haven't purchased a book, consumers that purchased a book the previous year, or consumers featured in the book 3× or more that haven't purchased. In other embodiments, the number of features may be 1×, 2×, 4×, or another number of features. In some embodiments, the coverage report e-mail may show a picture of the student that is used on a page in the yearbook. In other embodiments, the coverage report e-mail may include all or some other portion of the pictures that are in the yearbook of the targeted consumer/student.

During creation of the yearbook 26, staff members develop each page laid out during the planning stage. Development of each page may be done using a developer including photo manipulation, page manipulation, text, and graphic capabilities. Creation may involve customizing the template used, adding text, photos, clipart, or colors. In some embodiments, pages may be designated as “parent ad” pages. These pages may be customized by parents rather than yearbook staff Such customization may be done through the school or through a production facility, described more fully below. It is to be appreciated that, during creation, users of the yearbook system may vary from the plan and that the plan may merely provide guidance during creation. Once the page is complete, the page may be submitted for production 28. Submissions may be done by individual page or in a grouping of pages. Submission may be done from a build ladder (described below) or from the developer. If the page was created using a desktop publishing application, a printed page from a production facility may be returned to the staff for proofing. The yearbook staff may also be responsible for the selling of the yearbooks 30. The yearbook staff may use the present invention to design merchandising materials and track sales of the yearbook. After the yearbook has been sold and printed, the present invention may be used for aid in the distribution of the yearbooks 32.

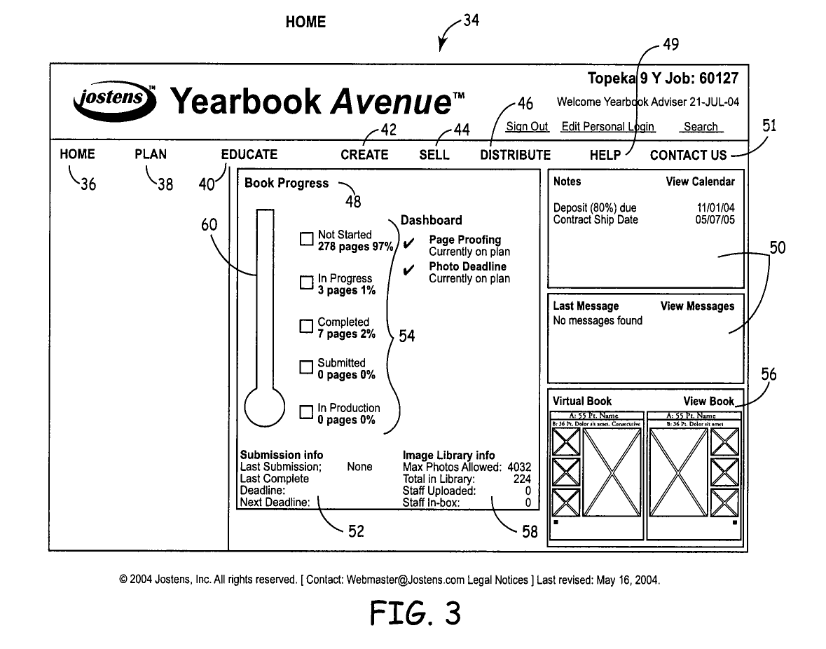

FIG. 3 illustrates a yearbook system home page 34 in accordance with one embodiment of the present invention. As shown, the yearbook system has navigational features to each of Home 36, Plan 38, Create 42, Educate 40, Sell 44, and Distribute 46. Other navigational features may be included to Supplies, Help, and Contact Us. Two types of information are provided within each of these categories: information specific to the school and informational content. Some of the informational content available is dynamic content that may be changed or updated. That information tends to be important for the type of information provided while the specifics of the information being less important.

The system home page 34 shown in FIG. 3 may be customized for each school using the yearbook system. Generally, the system home page provides a summary of the information specific to the school that may be otherwise accessed through the Home 36, Plan 38, Create 42, Educate 40, and Sell 44 tabs. In some embodiments, the home page 34 provides a snapshot view of the yearbook progress 48, notes and messages 50 regarding the yearbook, deadline status 52, submission information 54, and/or a virtual book access 56. Further, the system home page 34 may include Image Library Information 58 regarding photos submitted by the school or others such as the maximum number of photos allowed, the number of photos currently in the library, the number of photos uploaded by the staff, the number of photos currently used in the book, the number of photos currently in the staff in-box (prior to placement in the library), and other information. In some embodiments, one or more deadlines may be incorporated into the planning of the book and may be displayed on the system home page. Deadlines may include, for example, submission deadlines, order deadlines, delivery deadlines, and the like. The deadlines may include default deadlines which may be automatically set based on a typical progression of the yearbook creation process. Default deadlines may be manually adjusted by an authorized individual, such as an advisor or editor. The deadlines may further, or alternatively, include preliminary deadlines and final deadlines. Each preliminary deadline may be correspond with one or more final deadlines, and be assigned a date which is a predetermined period before its corresponding final deadline. The preliminary and final deadlines may be set by, for example, an advisors, system administrators, or the like. In one embodiment, if a deadline is a preliminary deadline, said deadline may not be indicated as such to selected users of the system such as, for example, yearbook staff.

A progress bar 60 or status indicator may be provided on the yearbook system home page 34 for giving a visual illustration of the progress of the yearbook creation. As shown, the progress bar 60 can illustrate the number and percentage of pages not yet started, the number and percentage of pages currently in progress, the number and percentage of pages completed, the number and percentage of pages submitted, and the number and percentage of pages in production. Thus, a school may visually track their progress in creating the yearbook. Generally, any suitable tool may be used to chart progress on the yearbook. In some embodiments, such tool may show completed pages. In some embodiments, the system may provide practice pages to schools. These practice pages generally may be set such that they do not affect the progress bar.

An Advisor Recognition Page or program may be provided with the yearbook system. The Advisor Recognition Page may include tips and tools for advisors for meeting key deadlines and content for the yearbook. The Advisor Recognition Program may be associated with the progress bar. With an Advisor Recognition Program, points may be associated with each of deadlines and specific content areas such that points are tabulated during the year and the advisor is recognized upon reaching a certain number of points.

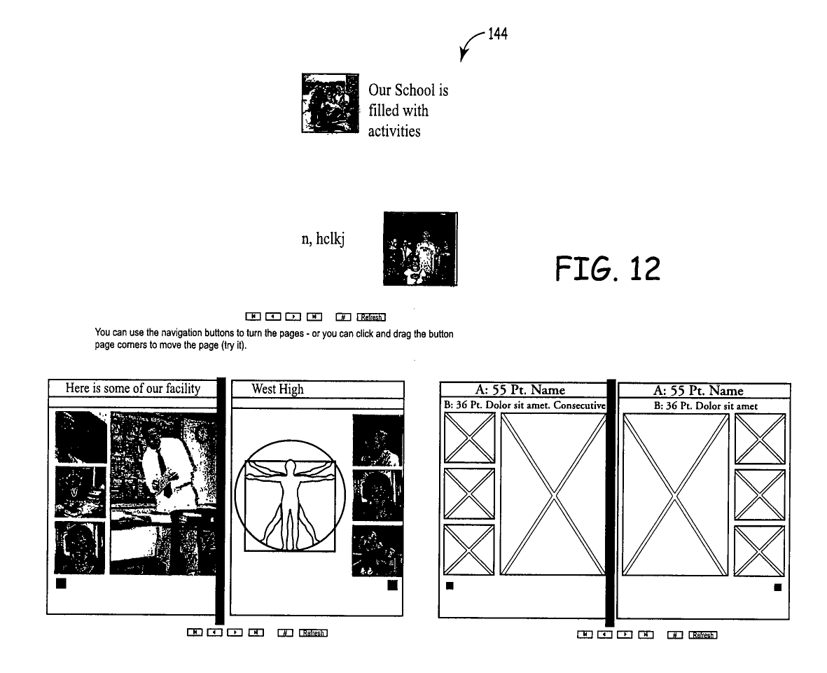

The yearbook creation summary page 34 may further provide a link to a Virtual book 56. Virtual books are described more fully in relation to FIG. 12. Briefly, the virtual book provides a flip-through virtual book of pages not started, currently in progress, completed, submitted, or in production. In some embodiments, one or more of the pages may be hidden such that the content of the page is not shown to all viewers of the virtual book.

As stated above, the yearbook system provides a tool for use from the start to the finish of the yearbook process. The yearbook system may be used for educating yearbook staff regarding the yearbook process, for planning the yearbook, for creating the yearbook, for facilitating external contributions to the yearbook, for selling the yearbook (including merchandising), and for distributing the yearbook. Each of these categories are discussed below. Some of these categories are discussed in relation to example web pages associated with the category. The web pages shown are illustrative of pages that may be used in a yearbook system in accordance with the present invention. However, each page, or a similar page, need not be used, and actual pages implemented may vary from those shown. Further, variations may be obvious to one skilled in the art and are intended to be included within the scope of the present invention.

### Educate

The yearbook system home page 34 provides an Educate tab 40 for accessing Educate information. The Educate information includes information useful for a staff advisor to educate yearbook staff regarding the year book process and is generally informational content. Generally, the Educate information is dynamic content that may be changed or updated with some frequency. The Educate information may include publication information and classroom tools. Publication information may include recommended magazines and books devoted to the yearbook process. Classroom Tools may include teaching plans, teaching examples, and other tools useful for a staff advisor for teaching the yearbook process in a classroom setting.

The Educate tab may include an Ideas & Tips section. The Ideas & Tips section may have rotating information. The available information for rotation may vary depending on time of year. For example, at the beginning of the school year, available information may concentrate on planning of the yearbook.

### Plan

The yearbook system home page 34 provides a Plan tab 38 for accessing Plan Information. The Plan information includes information and tools useful for yearbook staff to plan the yearbook. Generally, the Plan information includes both school specific information and informational content. The informational content is typically dynamic.

Example informational content provided within the Plan information are cover, theme, and segment ideas. Such ideas may provide examples of covers used, themes developed, and segments created in other yearbooks. These examples are not generally intended for copying but are instead intended to provide guidance to yearbook staff in creating their own cover, themes, and segments to customize their yearbook. Further, as will be described more fully below, templates may be provided or may be developed by a school for use by a yearbook staff. Such templates may be referred to as “click 'n go designs”. Practice pages from current or previous years may be provided within the Plan information.

School specific information provided within the Plan information may include a planning ladder, fonts, styles, community photo site, staff management, school information, book configuration and key dates, and payment information. An indexing tool may be provided with the Plan information for indexing photos used in a book and for generating a coverage report, discussed below.

FIG. 4 illustrates a planning tool used to lay out the groundwork for creating the yearbook. The planning tool, which may hereinafter be referred to as Planning Ladder 60, may provide a thumbnail image 62 of each page (whether complete, partially created or still in template form). At the beginning of the planning stage, each page may be blank or may be in template form. Associated with each thumbnail page image may the following information: section 64, description 66, deadline 68, staff 70, page type 72, template 74, or other. One or more staff members may be associated with each page.

Thus, during planning, the yearbook staff may determine what section 64 of the yearbook the page will be in. Further, the planning ladder 60 visually indicates to the staff how many pages are allotted to each section. Similarly, the yearbook staff may assign a description 66 to the page within the section. Thus, for example, a section may be Fall Sports and a description of a page may be Girls Cross Country. The section 64 and description 66 may be entered by the staff. Each page may be given a template 74 for creating the page. In some embodiments, the exact template chosen may not be shown in the planning ladder—for example, a customized template designed using a desktop publishing application may not be scanned in and placed into the planning ladder. Alternately, however, such scanning and placement may be done. The system may include a tool for moving pages in the planning ladder, for inserting pages in the planning ladder, or for otherwise manipulating page placement on the planning ladder.

The system and method may include an outside contributor creation tool such as a parent ad creation tool. While this tool is specifically discussed with respect to content provided by a parent, the tool may further be used to facilitate content contribution by other members of the community. Thus, in certain embodiments, community members outside of the yearbook staff may add content to complete the yearbook.

In some embodiments, yearbook pages may be designated as “parent ads”. The parent ads may be grouped together in a single section or may be spaced throughout the yearbook. The parent ad pages may not include significant information in the planning ladder and may be left substantially blank for customization by parents. Generally, schools may offer ad space for purchase by parents. The school may set up an offer designating, for example, possible sizes, prices, templates, etc. In some embodiments, the school may require parent ads to use a specific template. Generally, in one embodiment, parents may access a creation tool through a system website and create a parent ad for submission to the school or production facility. Creation may include picking an approved template, uploading digital images (or sending pictures to a production facility for scanning), placing the images on the template, and adding text. The production facility may place the parent ads in places designated as “parent ads” on the planning ladder. Alternatively, the school may place the parent ads in places designated as “parent ads” on the planning ladder. Further, in some embodiments, the school may retain the ability to format the parent ad. In some embodiments, design of parent ads may be done using a desktop publishing tool or other creation tool.

A deadline 68 may be assigned to each page for when the page is to be submitted. Generally, the pages are set into signatures, for example a new signature starts every sixteen pages. Each signature may have an associated deadline. Thus, the deadline 68 associated with the page may be that of the signature of which the page is a part. Staff information 70 may be entered such as the staff member or members currently designated for creating and editing the page. Staff information may be edited or changed throughout planning and creation of the yearbook. The Planning Ladder 68 permits visual identification of the pages assigned to each staff member and the deadlines of the pages assigned to each staff member.

Page type 70 may be used to indicate whether the page is color or black and white. Generally, a signature (or a multiple—half of a signature) is assigned as color or black and white. Within a color signature, an individual page may be designated as black and white. Additionally, a portion of a page may be designated to have a high gloss effect as printed. This high gloss effect may be referred to as Spot UV. A tool for such designation may be provided with the yearbook system. Accordingly, a member of the yearbook staff may designate a portion of the page for high gloss effects or may designate an entire page for high gloss effects.

Color coding 76 may be used to indicate to what multiple the page belongs and whether that multiple is color or black and white. Typically, signatures are printed on the front and back of a single large piece of paper, with the paper then being cut and folded in a manner to create 16 consecutive pages. The pages printed on the front of the single large piece of paper are designated Multiple 1, the pages printed on the back of the single large piece of paper are designated Multiple 2. It may be useful to track to which multiple each page belongs so that, if 7 of 8 pages of Multiple 1 are submitted, the single non-submitted page may be priority flagged to be completed and submitted. Color coding may also be used to indicate whether the page is part of a double page spread (DPS). DPS pages are linked together such that one cannot be moved without the other being moved. Typically, DPS pages arise when a photo or theme crosses more than one page.

In various embodiments, yearbook staff may designate yearbook spreads comprising two pages, such as a double page spread, to have text flowing capabilities. An index tool may be provided for such designation. If so designated, the yearbook spread will allow text to flow from the first page to the second page automatically.

For easy reference during the creation process, color coding 78 may be used to indicate whether the page is complete, submitted, in production, or pending unsubmit. Within the Planning Ladder, pages may be moved, added, or deleted. The Planning Ladder sets the basis for the Build Ladder, described in relation to FIG. 18.

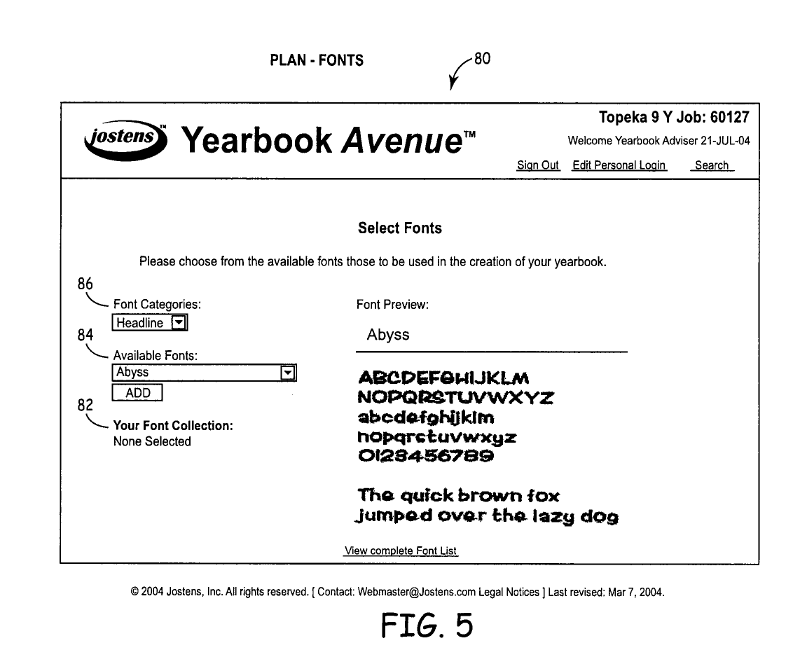

FIG. 5 illustrates a Fonts page 80 where the fonts for use in the creation of the yearbook may be selected. A font collection 82 is created on the fonts page listing what fonts 84 are used with what category 86. For example, it may be desirable for only one selected font to be used in headline category items. The font collection then lists what font may be used for headline category items. The font collection thus may be used to aid in providing consistency throughout the yearbook and limit the selection of fonts available. Fonts may include standard fonts available in desktop publishing and may also include special effects to the fonts—such as shadows, knock out or outline text, etc. The System may also enable full text rotation such that text inserted in a certain manner may be rotated.

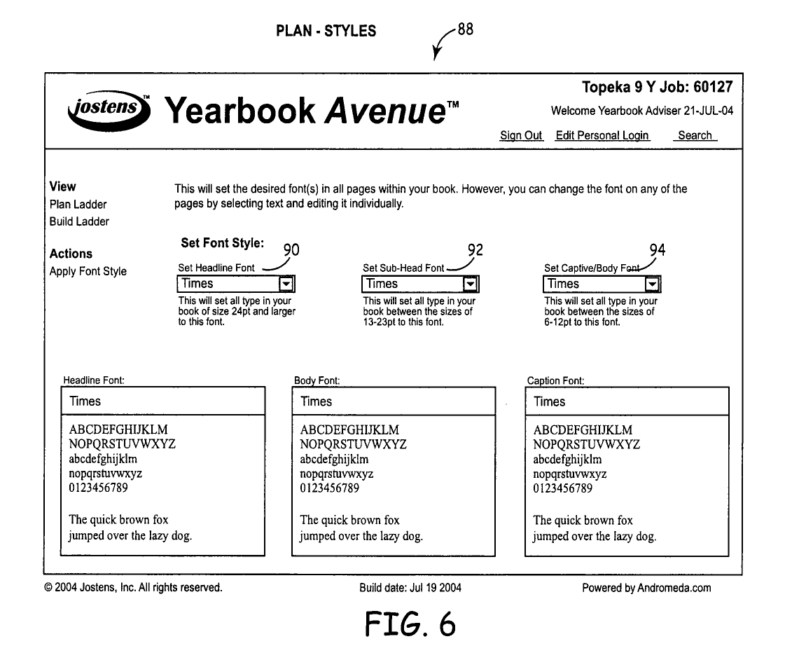

FIG. 6 illustrates a Styles page 88. The styles page 88 may be used to set the desired font in all pages within the book. A default font may be set for the headline 90, sub-head 92, and caption or body categories 94 throughout the book. The categories may be determined based on the pt size of the font used. Thus, for example, all fonts of 24 pt or larger are determined as headlines, all fonts of 13-23 pt are determined as sub-head, and all fonts of 6-12 pt are determined as caption/body. Regardless of style setting, the font selection may be changed on any of the pages by selecting the text and editing it individually. Generally, the changed font is compliant with the font collection of the Fonts page, shown in FIG. 5.

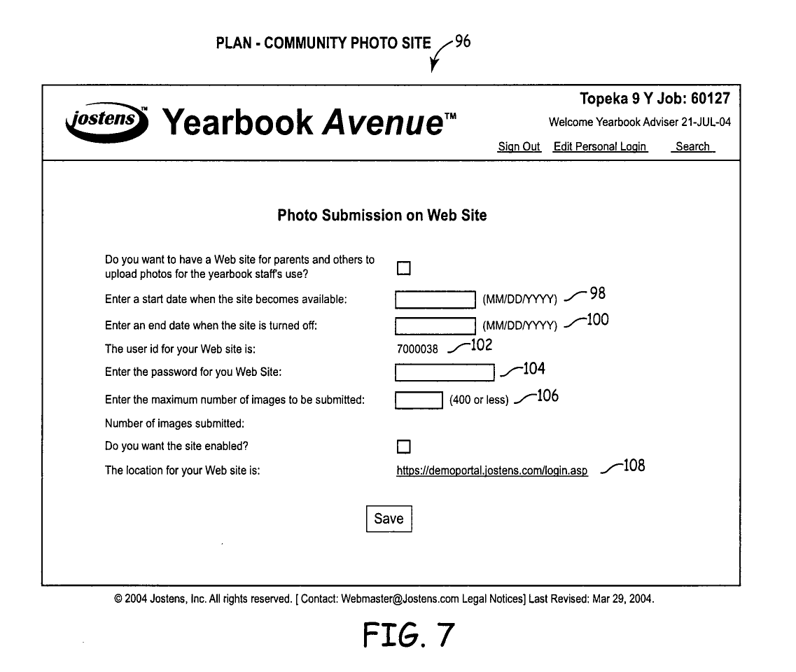

FIG. 7 illustrates a Photo Submission Web Site 96. This site may alternatively be referred to as an Image Share site or a Replay site. In some embodiments, the photo submission web site 96 may be a repository to permit others to submit photos for incorporation in the yearbook. For example, parents, non-yearbook staff students, and other people may upload photos to the site for the yearbook's staff to use. Further, in some embodiments, the school yearbook staff may load pictures to the photo submission site, including pictures used in the yearbook as well as pictures that are not used in the yearbook. In some embodiments, uploading of videos may be enabled on the Image Share site.

The photo submission web site may be hosted on the yearbook system site, by the provider of the yearbook system site, or at a different site. The photo submission website may be monitored by the provider of the yearbook system or by a third party to ensure that the photos uploaded to the photo submission site are school safe. Accordingly, any photo uploaded to the site, regardless of source, may be routed to a review process and put on hold for publication to the site pending review. In some embodiments, the review process of uploaded photos may include review by a third party moderation company or organization. In other embodiments, the school, or seller of the system, may monitor the photos. In any of these cases, limitations on photos may be provided and, as such, nudity, gang signs, alcohol, and drug related items, for example, will not be viewable on the image share site. Other limitations may also be provided.

To enable such a site, the following information is entered: a start date 98 for availability of the site, an end date 100 for the site, a user id 102 for the site, a password 104 for the site, and a maximum number of images 106 that may be submitted. A location for the website (a web address) 108 is then assigned. In some embodiments, the Image Share site may allow those with access to the site to view all photos uploaded to the Image Share site regardless of the source of the photos. In some embodiments, photos uploaded to the Image Share site may be tagged with information regarding the people in the photos. Such tagging may be enable any user of the Image Share site or an exclusive group of users (such as the yearbook staff) to view the photos. Untagging may also be enabled such that a mistakenly tagged picture may have the tagging removed and/or corrected. The tagging functionality may further be used to ensure a sufficient number of photos are available of all students of a school for inclusion in a yearbook.

The Image Share site may facilitate pulling of pictures from the Image Share site to the yearbook creation site such that the pictures are easily incorporated into the yearbook by the yearbook staff. Non-yearbook staff members may also have access to all uploaded pictures for use in creating personalized yearbook pages. In some embodiments, the system may facilitate autoflow of pictures into the personalized yearbook pages. The Image Share site further may allow downloading of pictures from the site and/or may link to a photo gift creation site such that students or parents may design photo gifts using photos uploaded to the Image Share site. In some embodiments, the Image Share site may enable sharing of videos.

The Image Share site may further be used by yearbook staff to provide added functionality to non-yearbook staff members. For example, a digital copy of the yearbook may be uploaded (and optionally password protected) to the Image Share site. A purchaser of the print yearbook may be given access to the digital copy. In some embodiments, the digital copy may have more content than in the print yearbook—for example, additional and/or related pictures may be accessible through the digital copy. In some embodiments, an additional number of pages may be available to the school yearbook staff for inclusion in the digital copy. These pages may be, for example, the “best of” pictures from the Image Share site. Depending on the number of pictures uploaded by non-yearbook staff to the Image Share site, yearbook staff pictures may be used in the extra pages. In some embodiments, the extra pages may be autoflowed with pictures in either a random order or based on particular content. For example, pictures may be autoflowed chronologically, according to class, according to activity, etc. In some embodiments, these pages may be provided as autograph pages.

The Image Share site may further be accessible via a mobile device such as an iPad, Android, iPhone, or other. Accordingly, the yearbook system may include applications that are downloadable to such mobile device.

In some embodiments, the image share site or Replay It site may allow staff members to have the option of selecting their school colors and uploading a mascot to show up on the Replay It site. The replay it site may be integral with the yearbook avenue system or it may be a separate system having communication capacities for communicating with the yearbook system. In some embodiments, the images, photos, or videos that are uploaded on ReplayIt are sent to the yearbook staff and show up on Yearbook Avenue in an “inbox”. Yearbook advisers may move images from the “inbox” to a photo category in their image library—to use the images in the book, for example. Photos that are uploaded to Yearbook Avenue by staffs may automatically show up on the image share site or replay it site, unless the adviser/staff chooses to not show the image or folder of images. For example, particular photos or folders may be identified as yearbook only such that the images, videos, or other files stored therein are not displayed on the image share site.

In some embodiments, the image share site may allow a user, such as the person uploading the photo, to create a caption. In other embodiments, staff, or other users may create a caption. Name and category tags may be added by selected users or any user for use in searching, autoflowing, or otherwise finding or arranging the photos on the site or database.

In some embodiments, the images may be flagged by users as inappropriate. In some embodiments, these images may be removed instantly by the system. These images may also be subject to further review by the school, third party moderation company, or other supervising entity. In light of the initial review process upon uploading, the image or photo may remain on the site until the additional review may be conducted, rather than being removed instantly.

In still further embodiments, a school may enroll in a time capsule program. The time capsule may wrap up the year in a digital format that may be accessed on the image share site or replay it site. In some embodiments, the wrapped up digital format may be accessed for future years by anyone that bought a yearbook. For example, the yearbook may have an printed code therein that may be used for accessing the time capsule.

The yearbook system may be integrated with the image share site in several ways. In one embodiment, automatically generated pages of the yearbook may be taken from the image share site. For example, a school may be provided with an extra 16 pages of content that will be in every student's book. For example, the 16 Pages may be auto-flowed with photos using 128 photos or more. The pages may be auto flowed at a selected date, such as in early December, for example. Other numbers of pages may be used and other numbers of photos may also be used. In some embodiments, the photos for autoflowing of the yearbook pages may first pulled from the images that are uploaded to the image share site. Where there is insufficient photos to fill the selected number of pages, images that have been otherwise uploaded to the system, such as staff-uploaded photos, may be flowed to the pages next. Other arrangements, preferences, and priorities may be given to the photos that may be autoflowed to the pages. In some embodiments, yearbook staff may swap out and resize photos if they choose

In some embodiments, the yearbook system including the image share site or Replay It may include functionality for sharing items from the yearbook or portions of the yearbook via email or to social network sites such as a personal facebook page or a school facebook page.

Through the Yearbook Creation Home Page 34, staff may view how many images have been submitted. In one embodiment, the uploaded photos are placed on a quarantined site for viewing by the staff advisor to decide whether the photo is to be used. Once selected for use, the photo may be transferred to the Image Library. In some embodiments, parents and others may send photos to a production facility to be scanned in and uploaded to the system, via the Photo Submission Web Site 96 or other. In some embodiments, a user may designate a photo submitted to the photo submission web site as upload- or download-able such that a further user may download the photo for printing. Thus, the photo submission web site may further operate as a photo sharing site.

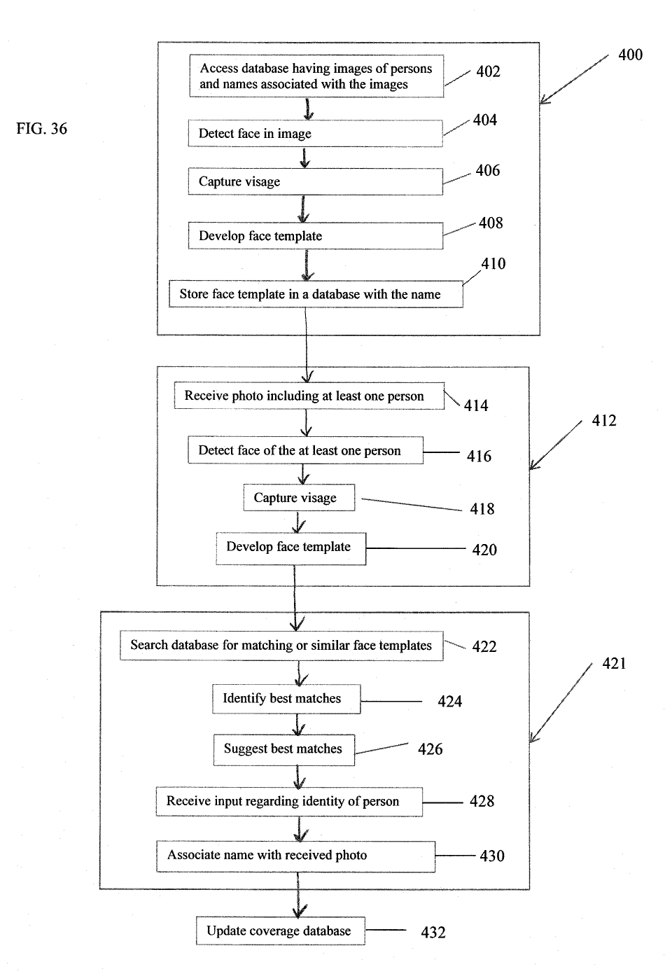

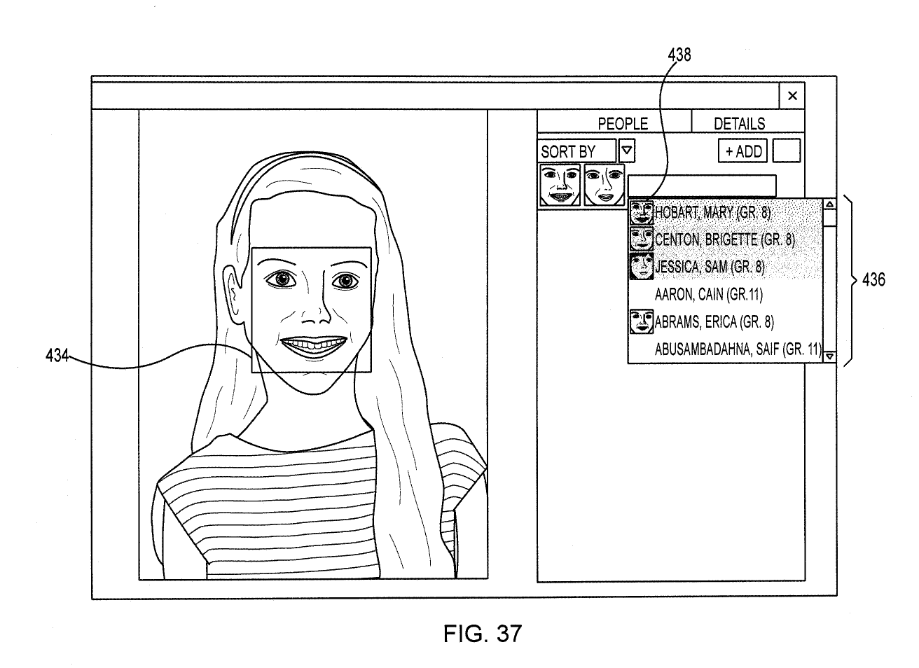

In some embodiments, the yearbook system may include functionality for facial recognition and assisted image tagging. In these embodiments, a reference database may be initially established such that later images may be compared with the reference database to identify individuals in the later images. The later images may then be tagged with information relating to the individuals in the image and the coverage report may be updated to reflect the appearance of the individual or individuals in the later image. These embodiments may be advantageous for streamlining updates to the coverage report and otherwise tracking the number and location of appearances of individuals in the yearbook, for example.
With reference to FIG. 36, several operations of the present embodiment are shown. In this embodiment, a first set of operations may relate to establishing a reference database. (block 400). In some embodiments, the reference database may be established based on a set of portrait images. That is, for example, where school pictures are taken by a photographer, an initial data set including images of the students in the school associated with their respective names may be available. In the present embodiment, the reference database may be established based on these portrait images. The system may access the initial data set (block 402) stored on a local server or stored in another location. For each portrait image, the system may detect the face in the image (block 404). That is, the system may establish the boundary of the face apart from the neck and shoulders and any background in the image. In addition, the system may capture a visage of the face in the image (block 406). A visage may be a portion of the face smaller than the whole face of a person, but including portions of the face that may be used to identify a person. For example, as shown in FIG. 37, the visage 434 may be a generally rectangular area of the face including the eye area, the nose area, and the mouth are of the face. Other portions of the face may also be used. Having captured a visage, the system may develop a face template (block 408) allowing one or more faces to be compared. The face template may be stored in the reference database and it may be associated with or tagged with the name of the student, for example. (block 410). Where additional portrait images (e.g., more than one) are available, additional face templates may be developed and stored in the database to help increase the accuracy of the later identification of individuals. For example, two, three, or more templates may be provided.
An additional set of operations may be used to develop a face template of individuals in other images for comparison to the templates in the reference database. For example, where the photos of students are taken throughout the year at school events, during student activities, in classrooms, or throughout the school, these activity photos are often used in yearbooks in addition to the portrait images taken by the photographer mentioned above. At block 412, the system may provide one or more operations for handling these activity photos. For example, the system may receive activity photos (block 414) in that the photos may be uploaded to the yearbook system by yearbook staff, students, or others with access to the system. As with the portrait images, the system may detect a face in the activity photo (block 416). However, in this operation there may be multiple faces in a given photo where, for example, a photo of a group of friends is taken at a football game or other sporting event. Accordingly, the detect a face operation (block 416) may involve detecting one or more faces in the activity photo and in the subsequent operation where a visage is captured (block 418), each detected face in the photo may have such a visage captured. At block 420, each visage may be used to develop a face template.
Having developed face templates for the individuals pictured in an activity photo, at block 421, the face templates may be used to identify the individuals in the photo. In this embodiment, the system may search the reference database for reference face templates closely resembling the face templates of the activity photo (block 422). The system may identify the best matches (block 424) and may suggest the best matches to the user of the system (block 426). For example, as shown in FIG. 37, the best matches may be suggested in the form of a list 436 of names having the closest matches at the top. In some embodiments, the portrait image, the visage, a thumbnail image or other photo or portion of a photo 438 from the reference database may also be provided with the list 436 of names so the user can rely on that for comparison to a particular individual in an activity photo, for example. Upon review of the best matches the user may identify or confirm the identity of the individual in the activity photo and the system may receive input from the user of the individual's identity (block 428). The staff person may also deny the findings of the facial recognition software and may manually enter a tag for a newly uploaded photo where the facial recognition software is in error or if the software does not offer a selection, for example. The system may then tag the activity photo by associating the name of the individual with the activity photo (block 430). Where multiple individuals are pictured in an activity photo, the system may compare each face template of each individual to the reference database, provide suggested matches for each individual, receive input regarding each individual, and associate the name of each individual with the activity photo. As such, an activity photo may be tagged with one, two, or several names.
With the activity photos tagged, the coverage report may be updated (block 432). For example, if the system identifies three students as appearing in an activity photo, the coverage report may be updated to increase the number of appearances for each of the students in the photo. In addition, the page of the appearance may also be added to the coverage report where the page of the activity photo is known. Accordingly, the use of facial recognition technology may streamline and automate the process of tracking the number and location of appearances of individuals in a yearbook. The coverage report may be updated automatically and may remain current up to the minute. Accordingly, notices sent to students regarding purchases, or their appearance in the yearbook, or otherwise may be sent relatively regularly without having to revisit the status of the coverage report every time.
As may be appreciated by one skilled in the art, any suitable facial recognition algorithms may be implemented in the system for performing the operations such as detecting faces in images, capturing visages, developing face templates, and comparing face templates. In some embodiments, the facial recognition software may be based on geometric or photometric approaches. The geometric approach focuses on distinguishing features, while the photometric approach uses a statistical analysis that transforms images into values and compares the values using templates to eliminate variances. Some particular algorithms that may be used include principal component analysis using eigenfaces, linear discriminate analysis, elastic bunch graph matching using the Fisherface algorithm, the Hidden Markov model, and the neuronal motivated dynamic link matching. Still other algorithms or combinations or portions of the listed algorithms may be used.

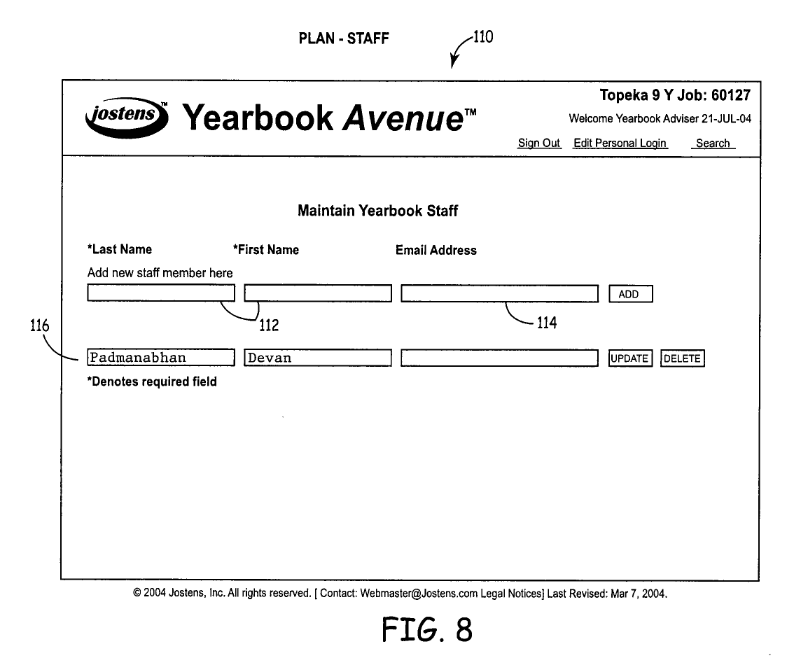

FIG. 8 illustrates a Yearbook Staff maintenance screen 110. The screen 110 provides the ability to add new members to the yearbook staff by providing a name 112 and, optionally, an e-mail address 114 or other contact information. Further, the screen lists all current yearbook staff 116. The current staff may be updated or deleted. Members of the yearbook staff may be given access to the yearbook system. Some areas of the yearbook system web site may only be accessed by a set level of staff. For example, only the staff advisor may be given access to the Educate Information. Further, the information available in the dynamic content areas of the site may depend on the staff level. Similarly, the actions available may depend on the staff level. For example, only the staff advisor may be permitted to submit a page for production. Accordingly, in some embodiments, yearbook staff may be given specific roles with specific access. These roles may include advisor, editor, business manager, and others. Staff entered into the Yearbook Staff maintenance screen 110 may be designated as responsible staff members for pages in the Planning Ladder 60. Further, it may be possible to track what pages each staff member is responsible for by searching the staff member name.

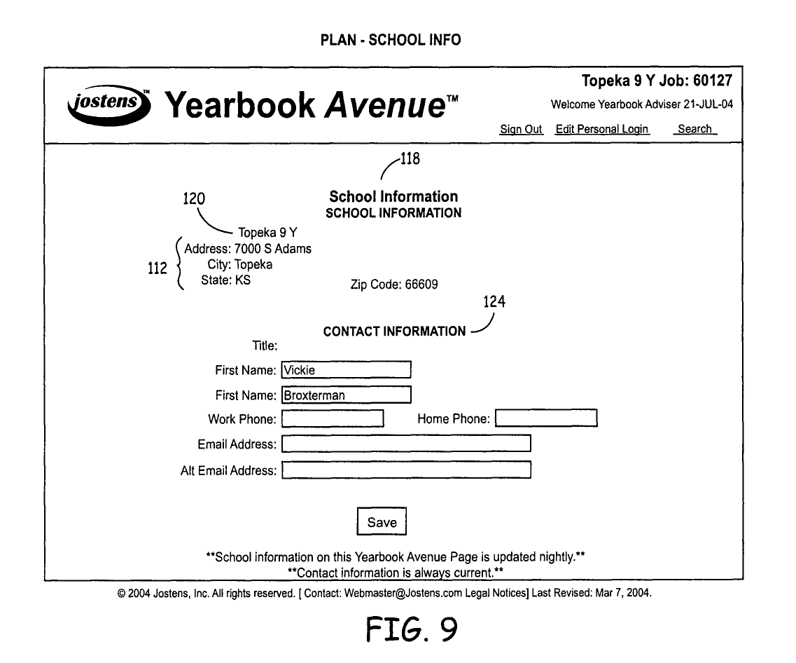

FIG. 9 illustrates school information 118 accessed through the Plan information. The school information 118 includes the school name 120 and address 122 as well as contact information 124. A contact person is listed on the school information and includes the title, name, work phone, home phone, and email address of the contact person. Typically, this contact person is associated with the school, such as the yearbook advisor. This information may be used for correspondence between production and the school.

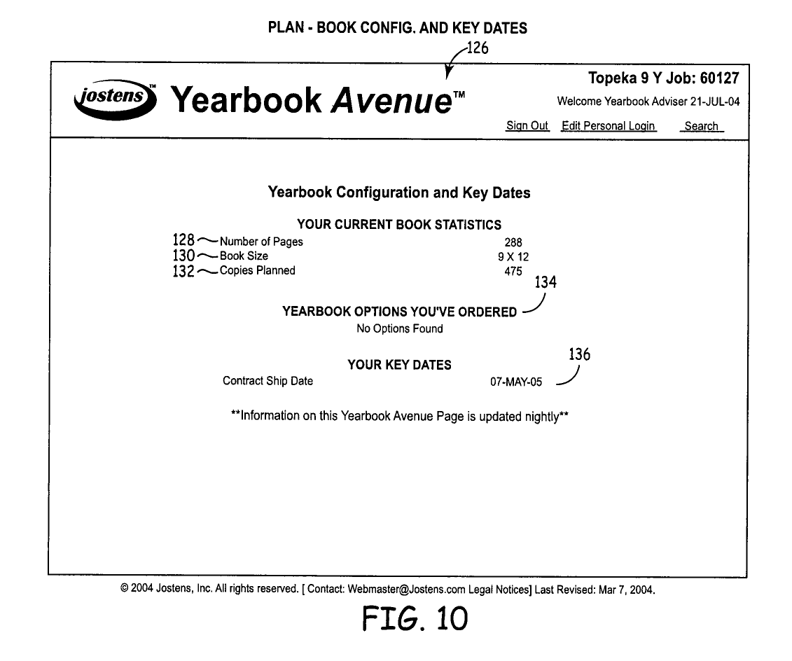

FIG. 10 illustrates a yearbook configuration information and key dates page 126. The yearbook configuration information includes the number of pages 128 planned for the yearbook, the book size 130, and the number of copies 132 planned for production. The yearbook configuration information and key dates page 126 may further list yearbook options ordered 134. The key dates 136 may include, for example, the contract ship date. For planning purposes, deadline dates and submission dates may be assigned backwards from the ship date. In some embodiments, “dummy” deadlines may be included in the key dates.

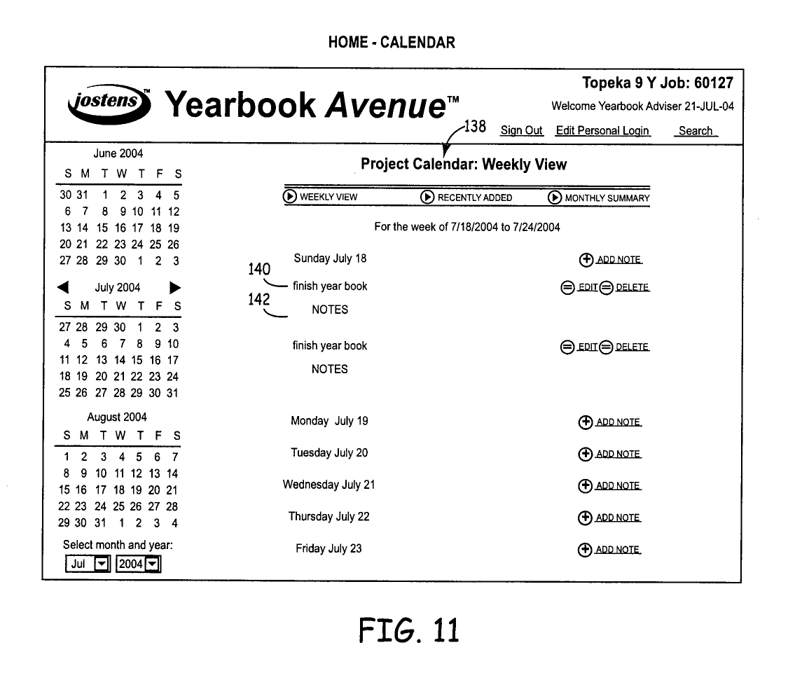

FIG. 11 illustrates a Project Calendar 138. The project calendar 138 may be viewed in a daily view, weekly view, a monthly view, a semester view, or other. An action item 140 and associated notes 142 may be entered under each date.

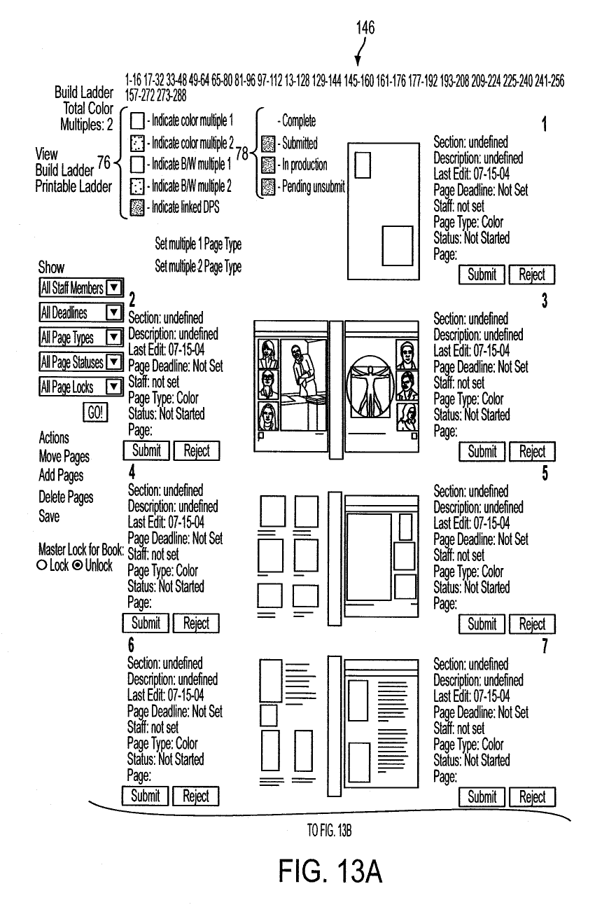

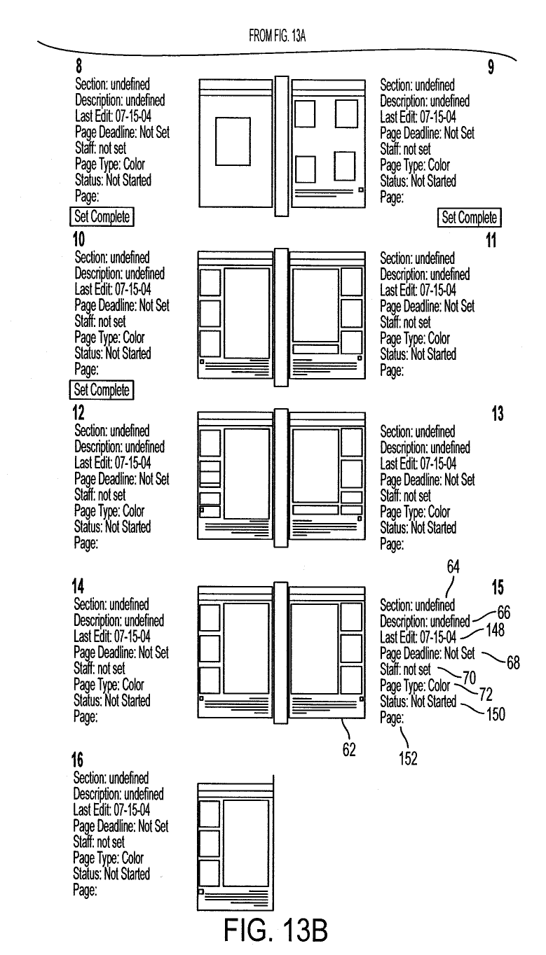

FIG. 12 illustrates a Virtual Yearbook 144 discussed in relation to the yearbook system home page 34. The virtual book 144 may be accessed via the virtual yearbook 56 section on the yearbook system home page 34, from the planning ladder 60 of FIG. 4 or from the build ladder 146 of FIG. 13, discussed later. The virtual book provides a flip-through virtual book of all pages not started, currently in progress, completed, submitted, or in production. The Virtual Yearbook may not be available in all embodiments. In some embodiments, it may be possible to click through a page on the Virtual Yearbook 144 to access editing capabilities for the page. Thus, clicking on a page of the Virtual Yearbook may direct you to the build ladder or to the page of the build ladder.

### Create

The yearbook system home page 34 provides a Create tab 42 for accessing Create information. The Create information includes information and tools useful for yearbook staff to create the yearbook. Generally, the Create information includes both school specific information and informational content. The informational content is typically dynamic.

Example informational content provided within the Create information are creation tools. Such tools may provide examples of the process of yearbook planning and creation.

School specific information provided within the Create information include a build ladder, a template builder, a template library, panel pages, an image library, photo coverage, an index, cover information, page submissions, messages, a complete page grid, and a summary report.

FIG. 13 illustrates a Build Ladder 146 in accordance with one embodiment of the invention. The basis for the Build Ladder 146 is set in the Planning Ladder 60 (discussed previously in relation to FIG. 4). The Build Ladder 146 may provide a visual representation of each page, such as by providing a thumbnail image 62 of each page (whether complete, partially created or still in template form). Associated with each thumbnail page image is information such as: section 64, description 66, last edit 148, page deadline 68, staff 70, page type 72, status 150 and page 152. The section 64, description 66, page deadline 68, staff 70, and page type 72 are described in relation to FIG. 4. Further, color coding 76 for DPS, multiple 1 or 2, and color or black and white is as described in relation to FIG. 4. In one embodiment, the Build Ladder 146 may be dynamic (i.e., the build ladder is updated as the pages are modified/edited). Last edit 148 indicates when the page was last modified/edited. Status 150 indicates the current status of the page, for example, complete, in progress, or not started. As with FIG. 4, color coding 78 may be used to indicate whether the page is complete, submitted, in production, or pending unsubmit. Other information may further be associated with each page in further embodiments.

A submit function 151 and/or a reject function 153 may be provided with the Build Ladder 146. The submit function 151 and reject function 153 may be provided as icons/buttons associated with one or more pages of the Building Ladder 146. In one embodiment, either or both of the submit function 151 and reject function 153 may be available for selected users only, such as advisors or editors.

A Page Mover tool may be provided with the Build Ladder 146 and/or the Planning Ladder 60. The Page Mover tool can facilitate moving of pages, swapping of pages, etc. such that users are easily able to modify flow of the yearbook. In some embodiment, the Page Mover may enable drag and drop functionality such that a page may be dragged and dropped into a new position, bumping subsequent pages accordingly. The Page Mover tool may also enable insertion of pages. The Page Mover tool thus may prompt a user to indicate whether a page should be inserted before or after a certain position in the book and may prompt the user how many pages are to be so inserted.

In some embodiments, a build ladder 146 showing partially created or completed pages may not be available. For example, a school using a desk top publishing application may not continually scan pages during the creation process for placement in the Build Ladder 146. Thus, only a template or blank page may be shown. Further, no build ladder 146 may be available in a desktop creation, or alternative embodiment, process. Alternately, a scanning and placement process may be used to periodically scan partially created or complete pages of a desk top publishing application for placement in the Build Ladder 146.

In embodiments showing created or completed pages, the build ladder may illustrate photos and images in high resolution or low resolution based on a user's or school's preferences. Thus, for example, where the user is accessing the system in a high connectivity environment, the build ladder may illustrate photos and images in high resolution. In contrast, where the user is accessing the system in a low connectivity environment, the build ladder may illustrate photos and images in low resolution.

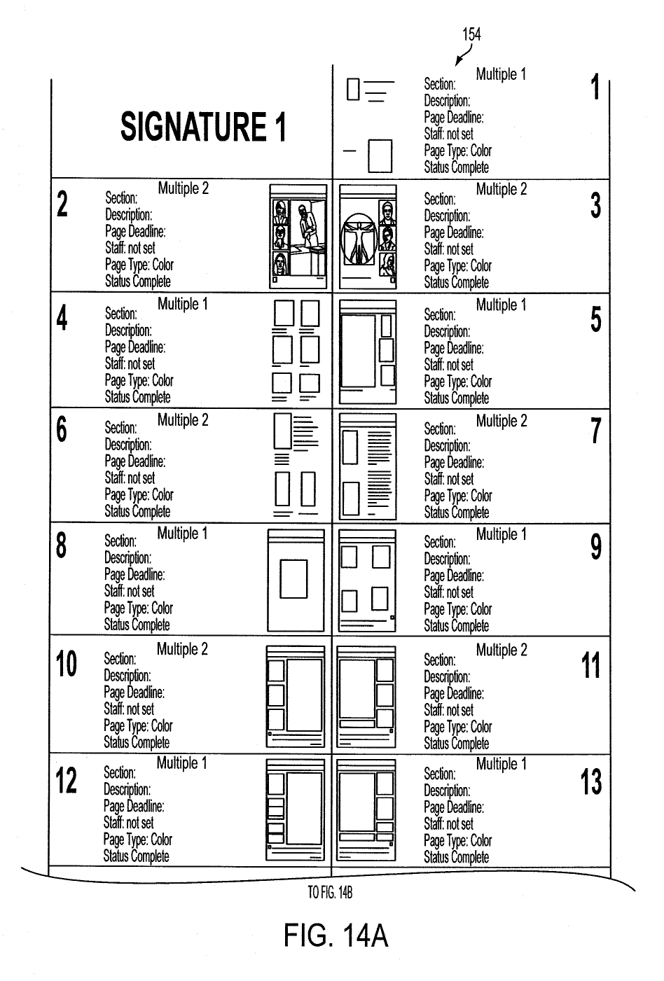

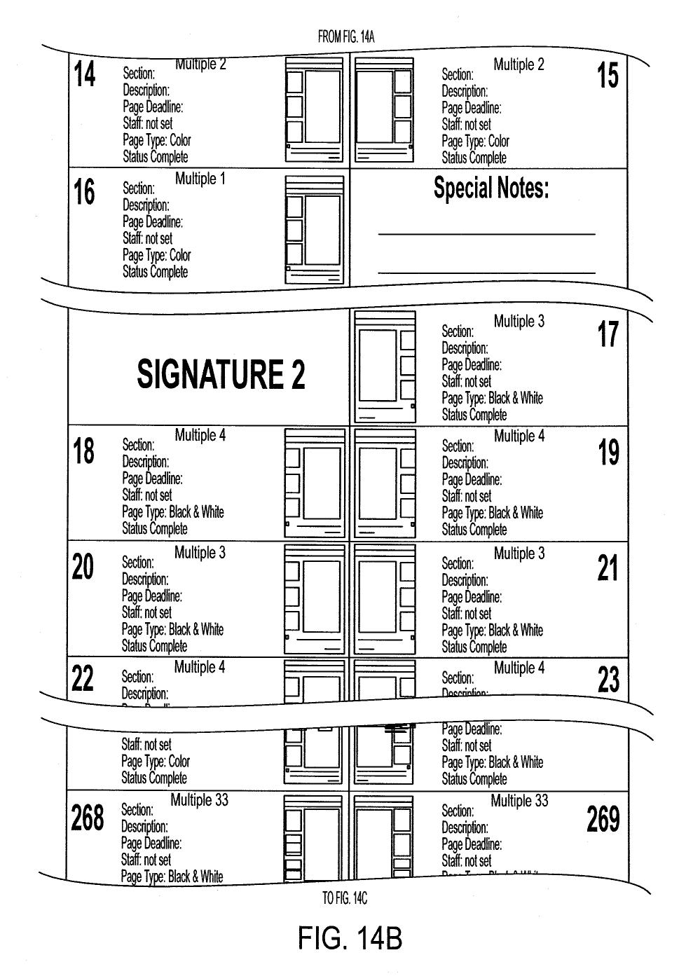

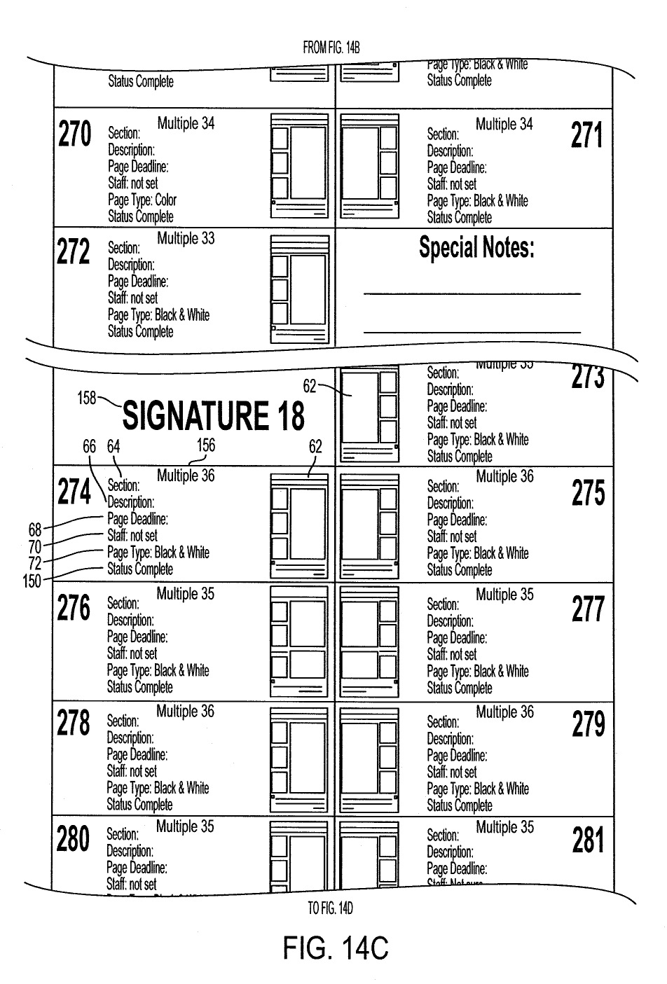

A Printable Ladder 154 may be accessed through either the Planning Ladder 60 or the Build Ladder 146 and is shown in FIG. 14. Like the Planning Ladder 60 and the Build Ladder 146, the Printable Ladder 154 provides a thumbnail image 62 of each page (whether complete, partially created, or still in template form). Associated with each thumbnail 62 is information such as: section 64, description 66, page deadline 68, staff 70, page type 72, and status 150. Also listed is to which multiple 156 the page belongs. Within the Printable Ladder 154, the pages may be divided into signatures 158. Thus, for example, the first sixteen pages may be associated with Signature 1, the next sixteen pages may be associated with Signature 2, etc. Spaces 160 for notes may be given such that the users or staff may write notes into the printed Printable Ladder 154.

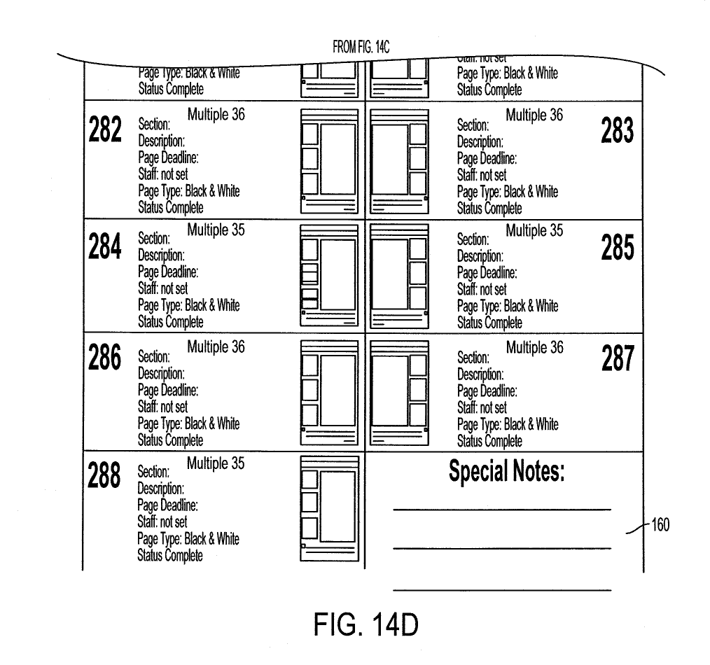

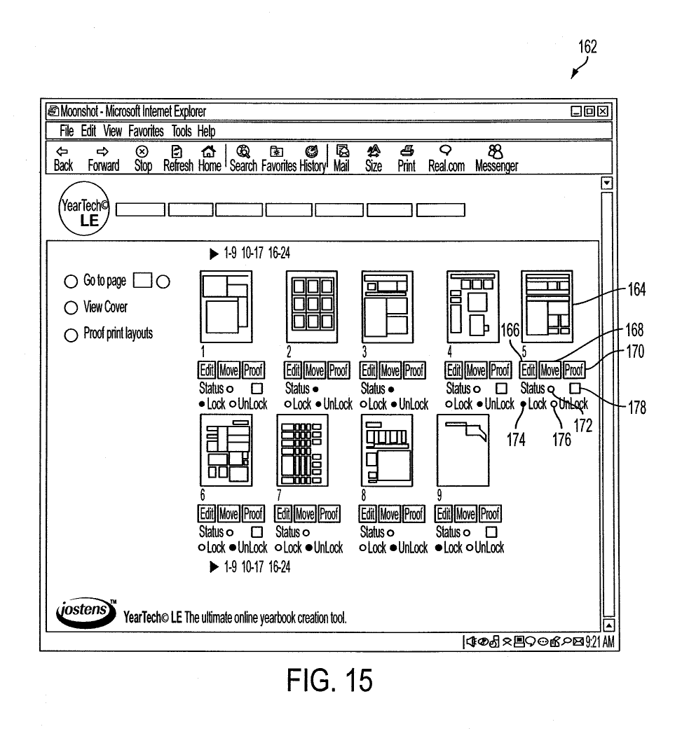

An alternate embodiment of a screen showing some of the information from the Build Ladder is shown in FIG. 15. FIG. 15 illustrates a page preview screen 162 showing thumbnails 164 of several designed pages. As shown, several thumbnails 164 may be shown on each screen 162. Options may be provided associated with each page, for example under each thumbnail image, allowing the user to choose to edit 166 the page, move 168 the page, or proof 170 the page. Other options may be provided as desired. A status indicator 172 may be provided associated with each page, for example under each thumbnail image 164. The status indicator 172 may change colors when the page has acquired a certain status. For example, if the status indicator is red, it indicates that the page has been submitted to the production facility and the page may be viewed but not edited. Lock and unlock buttons 174 and 176 may also be provided associated with each thumbnail 164. These buttons allow an advisor to lock or unlock pages. When a page is locked, a graphic of a lock 178 appears. A locked page may not be edited unless unlocked. In some embodiments, particular elements on a page may be locked. Submitted pages may not be locked or unlocked as submitted pages may not be edited regardless of lock or unlocked status. Lock and unlock options need not be provided. In some embodiments, a page may be “hidden” from view. Thus, for example, if a page is dedicated to a memorial, an advisor may hide the page from view from any user to keep the memorial page confidential until publication.

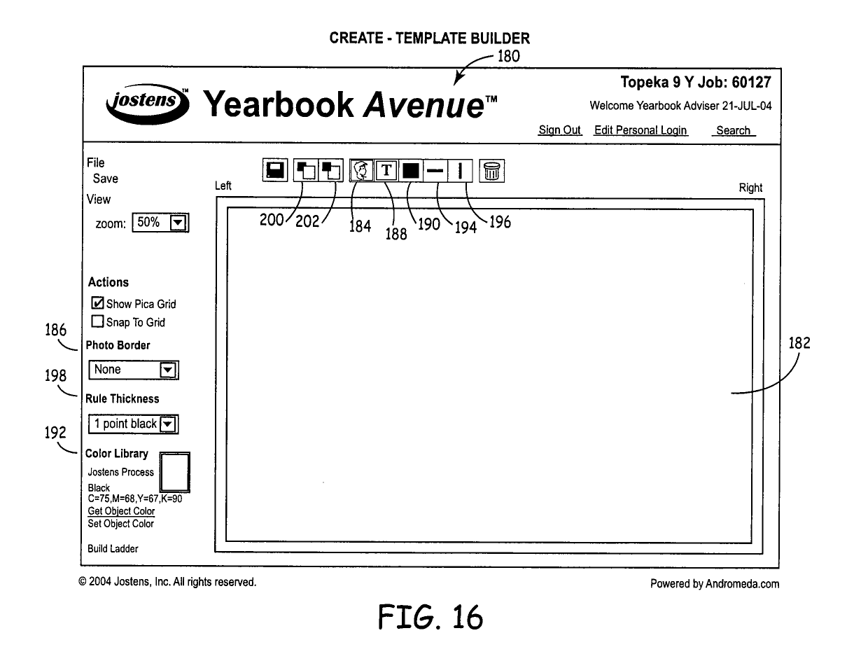

FIG. 16 illustrates a Template Builder 180 in accordance with one embodiment of the present invention. The template builder 180 provides a blank template 182 that may be customized by the user. Photo boxes may be added using the add photo box button 184. The photo boxes may include photo shapes such as circle, star, heart, octagon, square, rectangle, or other. In some embodiments, an existing photo box may be modified to a new shape. A photo border may be added using the drop down menu 186. Text boxes may be added using the add text box button 188. Color boxes may be added using the add color box button 190. The color may be selected from the color library 192. Added boxes may be moved and resized by clicking on the added box. Horizontal rules and vertical rules may be added by clicking on the add horizontal rule button 194 and the add vertical rule button 196 respectively. The rule thickness may be edited by using the drop down menu 198. Send backward and Bring forward buttons 200 and 202, respectively, may be provided for placing a picture box and/or text box in front of or behind another picture box or text box. In some embodiments, image boxes and text boxes may be freely rotatable, resizeable, and rescalable. In some embodiments, rotation may be in 15 degree increments. The text boxes and image boxes may further be moved on the page. The template may be saved as a specific template type for future use.

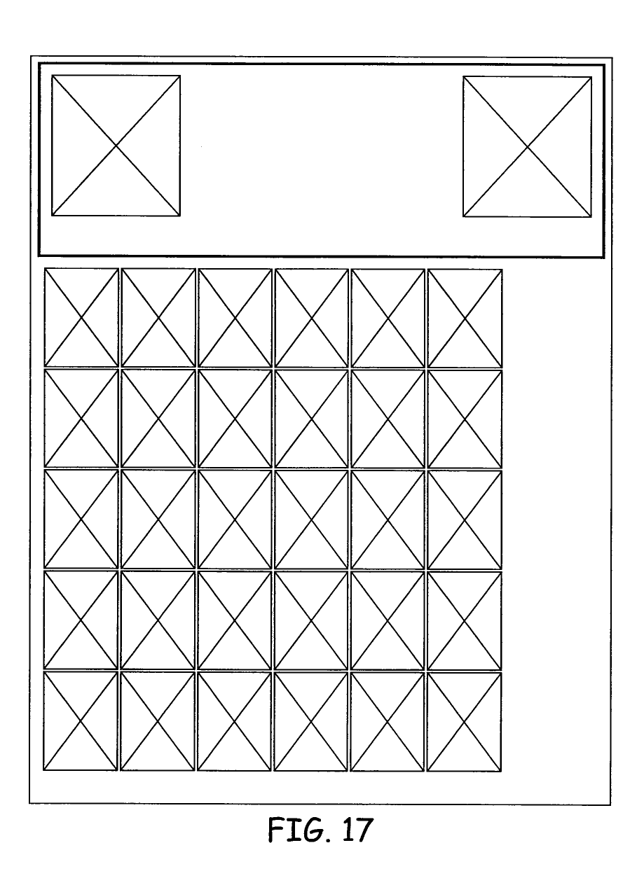

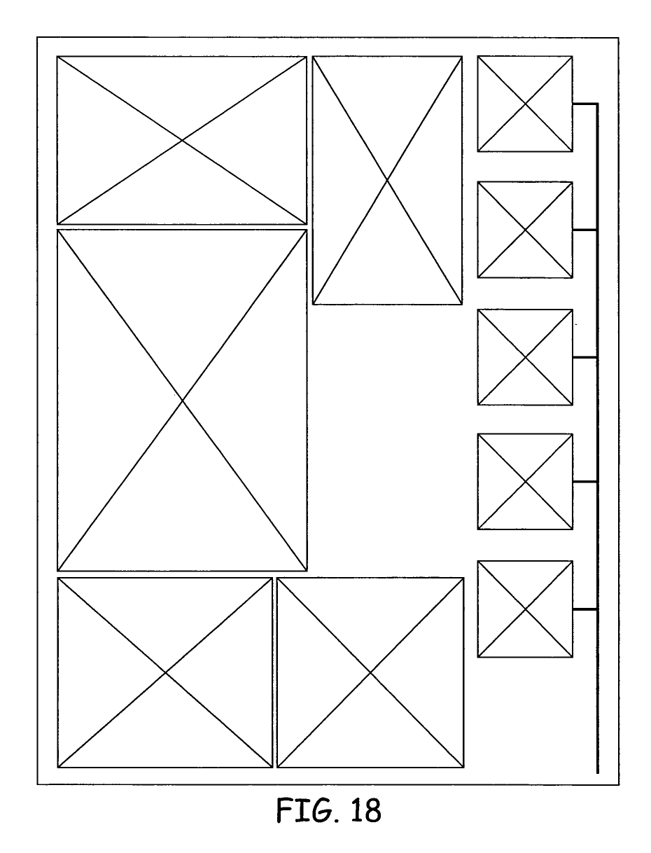

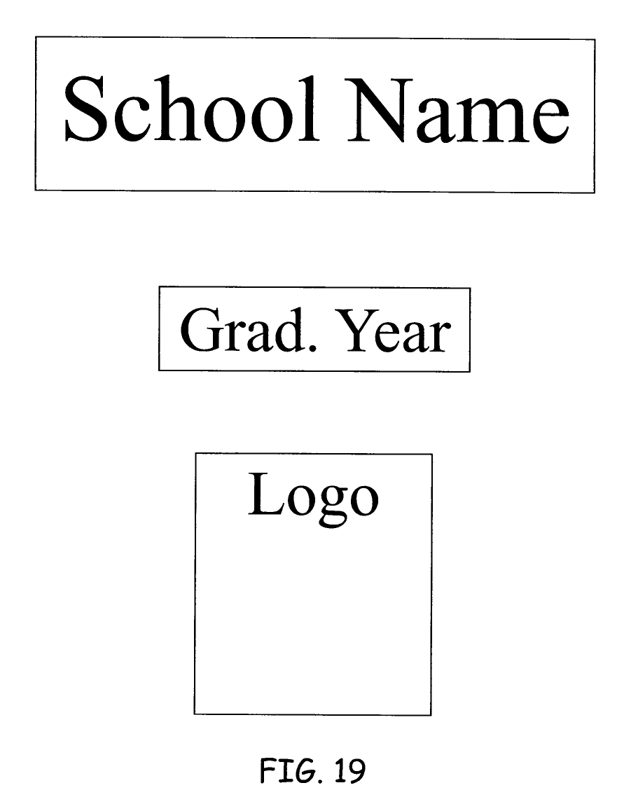

In addition to fully customized templates, standard templates may be provided for user customization, shown in FIGS. 17-19. FIG. 17 illustrates a portrait page template 204. FIG. 18 illustrates an activity page template 206. FIG. 19 illustrates a cover template 208. Of course, the templates shown in FIG. 17-19 are only examples. A wide variation of templates may be provided and used. In some embodiments, templates created or customized by a school may be saved from year to year such that yearbook staff need only customize the template with new photos or text.

In some embodiments, “click 'n go” templates may be provided. These templates may be a fully designed template wherein yearbook staff need only add pictures and/or text, may be partially created templates that require further customization, or may be a fully designed template that is customized and changed. For example, each template may be customized by adding elements such as headings, photo boxes, quarter pages, or half pages, and thus creating a custom template.

In yet further embodiments, templates may be provided as part of a Template Exchange. The Yearbook System provided herein may be an online system. Each school's portion of the system may communicate with a main system database. The main system database may include templates shared by a plurality of schools. This portion of the database may be termed a Template Exchange Folder. In some embodiments, the Template Exchange Folder may include one or more categories. For example, the Template Exchange Folder may include “Sports Templates”, “Prom Templates”, etc. Generally, the Template Exchange Folder may show sample templates without inclusion of actual text or photos—thus showing text boxes or photo boxes. The Template Exchange Folder may show templates in any order, such as in order of chronology by posting, in order of most popular, etc. In some embodiments, the Template Exchange Folder may only share templates of schools in like regions, or like categories (e.g., a religious school), or other. The Template Exchange Folder fosters sharing between schools and creativity of yearbook staff by facilitating publishing of work to others.

Generally, to complete a yearbook page, the staff member chooses a template, customizes the template, and adds photos and/or text to the template. Grids may be provided on the template to facilitate alignment during customization of the template. Thus, for example, a grid may be placed on the template and, when a user adds a photo box, the photo box may be “snapped to” alignment on the grid.

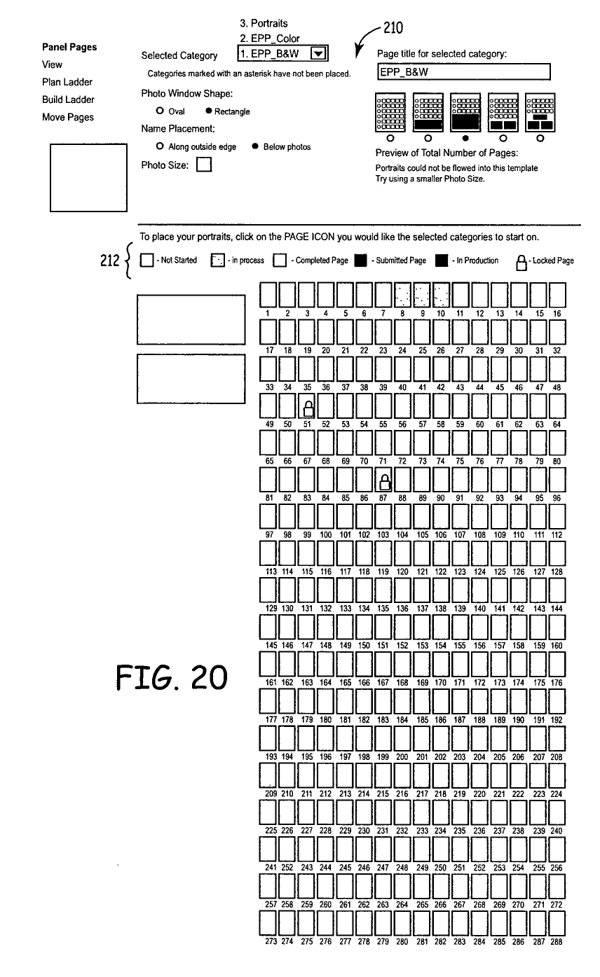

A Panel Pages screen 210 is shown in FIG. 20. Panel pages are portrait pages and have the student photos therein. In designing portrait pages, the user is prompted to choose the portrait size. Panel pages are pages in the yearbook devoted to student portraits. Typically, a photographer takes pictures of the students and loads the pictures as digital images onto a CD. The CD is shipped to the production facility and the production facility loads the images into categories. For example, all 10^{th} grade student photos are loaded into a 10^{th} grade category. Once the images are loaded by production, the school may proof the images and loading for accuracy. For example, duplicate images may be deleted, images in the wrong category may be moved, images of students whose picture was not originally submitted may be added, and student names associated with each photo may be checked. The photos are inserted into a panel page (or portrait page) template chosen by the school. The photos are loaded alphabetically as they would appear in the yearbook. Generally, the process of loading the images into the panel page is an automatic process and is driven by the template chosen by the school. Typically, the school is given a choice of pre-designed templates for selection as the panel pages template. Alternately, the school may design a customized template and then manually place each photo and text on the template or select flow of photos into the customized template. Accordingly, in some embodiments, the System may facilitate custom panel flow.

As shown in FIG. 20, the panel pages screen 210 shows a color-coded status 212 of each page, whether not started, in process, completed page, submitted page, in production, or locked. To place portraits, the user clicks on the page icon they would like the selected category to start on.

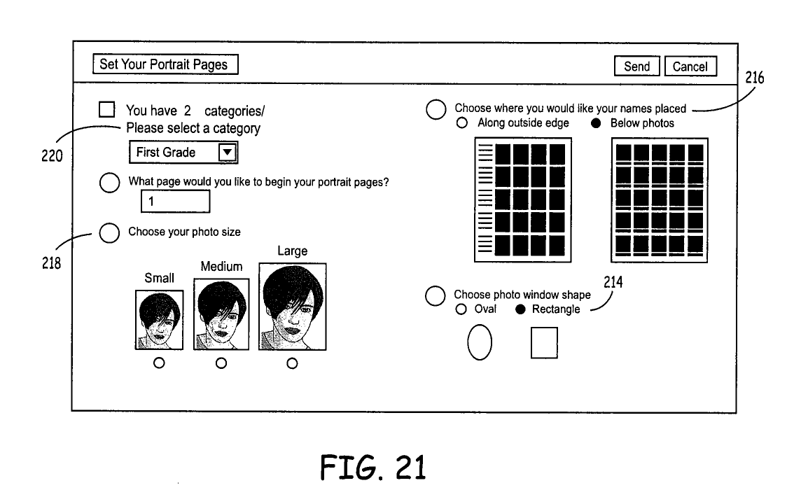

In an alternate embodiment, shown in FIG. 21, the user may be given several options during selection of a panel page template. The user may choose the portrait window shape 214, for example oval or rectangle. The user may choose where the names are to be placed 216—along the outside edge or below the portraits. The user may further choose the photo size 218 (small, medium large). In an alternate embodiment, the user may choose whether to include the minimum number of portraits per page, the normal number of portraits per page, or the maximum number of portraits per page. Thus, the user is given some flexibility in determining the total number of pages dedicated to portraits. The user designates the category 220 assigned to each page, for example, 10^{th} grade.

In some embodiments, the yearbook system may include a customizable spell check feature. Using this feature, a user may add custom words. This may be used, for example, to add student names. By adding student names to the custom spell check feature, a school may decrease the likelihood of a student's name being spell check corrected to a different, and possibly embarrassing, word. In various embodiments, the System may be provided with a spell check dictionary customized for the location of the school. For example, the System may be provided with an American English spell check dictionary for US schools and a UK English spell check dictionary for non-US schools.

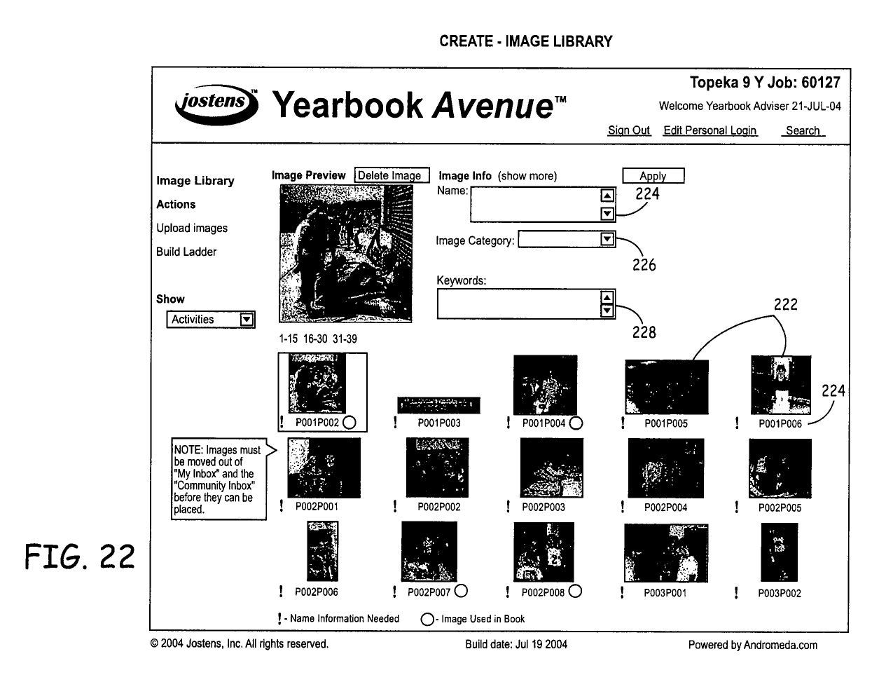

An Image Library page is illustrated in FIG. 22. In various embodiments, the Image Library may be provided with sub-categories. For example, the Image Library may be divided into sub-category folders such as Sports, Theater, Rallies, etc. Thumbnails 222 are provided of each of the images within the library. Photos may be uploaded to the Image Library by yearbook staff or outside contributors such as students or parents. The Image Library may also be configured such that photos may be downloaded from the Image Library for purchase or for further photo manipulation (and subsequent re-uploading). In certain embodiments, images may be auto-enhanced. Thus, uploaded images may be assessed based on histogram, color, and saturation and adjusted to best fit for its intended use. Auto-enhancement may be done at the time of uploading or at the time of placement in the book. In some embodiments, the production facility may auto-enhance images based on the printing equipment to be used to produce the yearbook. This may be referred to as post-production enhancement.

The System may be provided with photo manipulation capabilities. Photo manipulation capabilities may include color/image management enhancements. Incorporation of photo capabilities into the system facilitates start to finish yearbook creation using the system. Photo manipulation capabilities may include cutting out backgrounds, opacity manipulation, sepia tones, black and white tones, colorizing, adding an outer glow, red eye removal, etc. Cutting out backgrounds enables a user to cut around a feature of an image and remove the background. Opacity manipulation enables a user to modify an image from opaque to transparent such that it can overlay other features. Sepia tones, black and white tones, and colorizing enable manipulation of colors of the image.

Each uploaded image may be given a name 224, associated with an image category 226 and various keywords 228. For example, the names of each student appearing in the each photo may be listed associated with each photo. Other information such as keywords may further be associated with each photo. Thus, for example, a photo may be tagged with “girls cross country” to indicate that the photo is a photo of the girls cross country team. Thus, in some embodiments, the images may be searchable. In some embodiments, image categories and information may be hidden, based on user preferences or settings.

### TAGS

Image tags may be used to ascertain how many times a photo having that tag appears in the book. Images in the image library may be used during yearbook creation. Images must be moved from a staff inbox or community inbox before they may be used. Images may be uploaded to the image library. The image library thus provides a central repository for images that may be used in the yearbook. A status marker may be provided associated with each image, indicating whether a picture has been placed in the yearbook. Once a decision is reached that an image will not be used, it may be deleted from the image library. Deleted images may be stored at a production facility for easy recall.

In one embodiment, the System may include an image sharing tool configured to facilitate sharing of the images to individuals or other websites. The image sharing tool may be configured to allow for transfer of images in low or high resolution. The image sharing tool may be further configured to provide a link to the Photo Submission Web Site 96. The image sharing tool may be accessible to, for example, staff members, community members, or other third party content contributors.

In various embodiments, the System may be further configured to provide access to the yearbook and/or portions of the yearbook content to community members or other third party content contributors. For example, either or both of the image library and the virtual book may be provided to community members or other third party content contributors.

In some embodiments, certain images may be archived for use in future yearbooks. For example, business advertisements, pictures of the school, pictures of teachers or other school employees, etc. may be archived.

A photo coverage page may be provided as part of the Create information. The photo coverage page draws on the information associated with the image from the photo library to determine which students appear in which photos currently being used in the yearbook. Further, an index page may be provided listing each student and the page number on which they appear. Names may be automatically culled from portrait pages to create a database of students against whom coverage should be checked. Thus, the photo coverage page and the index page may be used to track appearance of students in the yearbook. A tracking system and/or alert system may be associated with the photo coverage page. Thus, for example, yearbook staff may input that each student should appear in the yearbook three times. The tracking system monitors coverage pursuant to the photo coverage page and may email tracking information to yearbook staff. As the yearbook nears completion, for example when it is 80% complete, the alert system may send out alerts that certain students appear fewer than the selected number of times. In some embodiments, the coverage report may only show students who appear in the book fewer than the designated number. The coverage report may further have logic to highlight entries for similar names, for example, “Arthur Mills” and “Art Mills”.

In some embodiments, the photo coverage tracking system may be linked to a purchase tracking system. Thus, the System may track students who appear in the book a certain number of times and who have not purchased a yearbook. The System then may generate a customized notification, such as an email, letting the student know that they appear in the yearbook and soliciting them to purchase the yearbook. In some embodiments, the customized notification may include details about the student's appearance in the yearbook such as by incorporating one or all of the images featuring the student.

In some embodiments, the coverage reports may provide further information regarding each student. For example, the report may comprise a master list that indicates how a name is indexed, allows editing to the list, and provides sales data regarding a student in addition to indicating pictures showing the student. This may be referred to as a single student list.

In some embodiments, schools can upload a student list and then as yearbook staff place images on pages, the staff can choose a name from the student list to tag, and the system may track how many times the selected student is in the yearbook. This information may be stored and/or presented in a coverage report. If a student list is not uploaded by a school or other user, the system may create a student list based on information received from a school photo photographer. For example, the selected or hired photographer may provide the school with a portrait CD that may include an index with student names associated with photos and may further include grade level, for example. Other information may also be provided by the photographer.

In some embodiments, the system may allow a school to import their student list from last year. In some cases, the system may allow for importing particular grades, such that seniors or other students that may have graduated or otherwise moved on are excluded from the list for the current year. As such, in addition to grade level, the coverage report may include a field for indicating the plans of the student for the following year, such as graduating, graduating early, transferring, etc. Where the photo coverage tracking system is linked to a purchase tracking system as discussed above, the coverage report may be updated when a student purchases a yearbook. This may occur automatically through the system if the yearbook is purchased online, or data may be entered to indicate purchase. In either case, the coverage report may include information indicating that a student has purchased a yearbook and, as such, e-mails, notifications, or solicitations to those that have already purchased may be avoided.

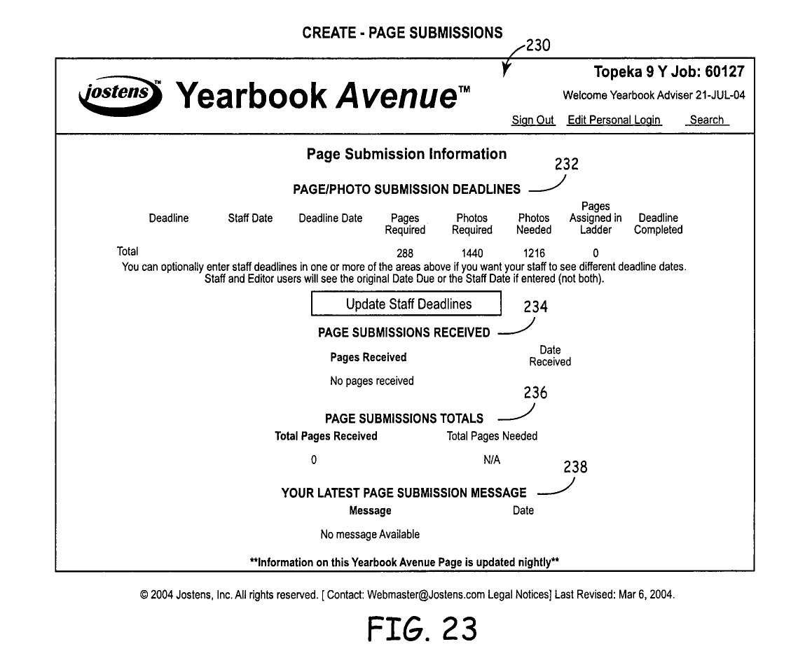

A Photo Submissions Information page 230 is illustrated in FIG. 23. As shown, the photo submissions information page 230 may include information on the page/photo submission deadlines 232, the page submissions received 234, the page submission totals 236, and the latest page submission message 236. In addition to the deadline date for the page/photo submission deadlines, the number of pages required, the number of photos required, the numbers of photos still needed, and the pages assigned in the ladder (planning ladder or build ladder) may be listed.

Pre-licensed images and news items may also be provided within the Create information. For example, images or news stories from significant world events may be provided available for use by the school in the yearbook. Thus, for example, during an election year, images may be provided of the candidates or of the campaigns. As another example, if the school is located in an area where an earthquake had occurred, images may be provided of the aftermath of the earthquake. Similarly, trademarks or copyrights may be pre-licensed and available for use by the school. For example, particular copyrighted or trademarked graphics may be made available. By having access to pre-licensed images, the school can include a wide array of current events information without having to individually seek out permission.

Using the yearbook system, a custom cover may be designed. Numerous possible combinations of cover workflows include silkscreen, art, foil, embossing, graining, matelay, casemaking, die cutting, lamination, handwork and overtone. Custom cover artwork may be submitted by the school, scanned at the production facility, and made available on the yearbook server. A template for a custom cover may include one large image and no text. Alternately, a stock cover with school personalization, such as school name and mascot, may be used.

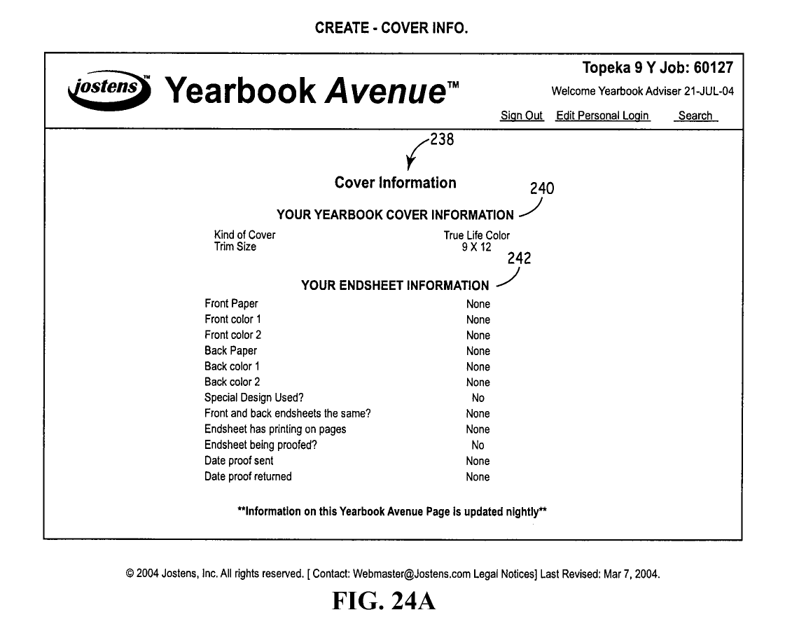

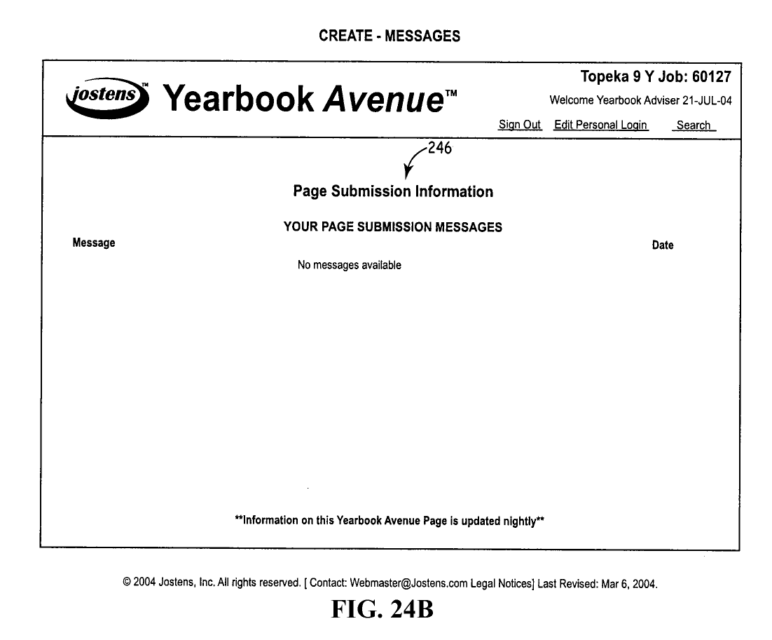

A cover information page 238, as shown in FIG. 24A, may be provided. The cover information includes both information about the cover 240 and about the endsheets 242. The cover information 240 includes the kind of cover and the trim size.

In some embodiments, the endsheets may be custom endsheets. The endsheets are the pages that hold the book block to the book cover. The endsheets appear as sheets but generally have a different size and may be treated differently from other sheets in the book. In some embodiments, the endsheets may be customized. The endsheet information 244 includes the front paper, the front color 1, the front color 2, the back paper, the back color 1, the back color 2, whether a special design was used, whether the front and back endsheets are the same, whether the endsheet has printing on the pages, whether the endsheet is being proofed, the date the proof was sent, and the date the proof was returned.

FIG. 24B illustrates a Messages page 246. Typically, messages are to the advisor and relate to key events. The messages may be automated, such as acknowledging receipt of a submission. Alternately, the messages may have in depth information such as deficiencies or problems with a submission. The messages page 246 facilitates communication to the advisor during yearbook creation.

In alternative embodiments, yearbook staff may leave “notes” to one another. These notes are tabs that may be placed on the shared document and including information such as name of poster, note, time posted, etc. The note may be a non-printable element. The notes facilitate communication and collaboration between yearbook staff. In some embodiments, only the poster of the note may remove the note. In other embodiments, the note may have a designated addressee and only the addressee or poster may remove the note. In yet other embodiments, anyone with access to the page on which the note is placed may remove the note.

In further embodiments, the System may be provided with a live chat feature such that chat may be enabled between any staff members online at a given time. In various embodiments, the chat feature may facilitate individual chat or global chat. For example, in individual chat, a staff member may individually instant message (IM) another chat message. In some embodiments, the IM may create a chat window on the screens of the individual staff members. In global chat, a staff member may globally message any online members. In some embodiments, the global message may create a chat window on the screens of all staff members.

### Page Creation

As previously described, to create a yearbook, the yearbook staff begins by using the planning ladder. Using the planning ladder, the yearbook staff designates certain pages or portion of the books as intended for certain categories. For example, the staff may designate certain pages as devoted to sports, certain pages as devoted to community involvement, and certain pages as panel pages. Staff members may be assigned to certain pages.

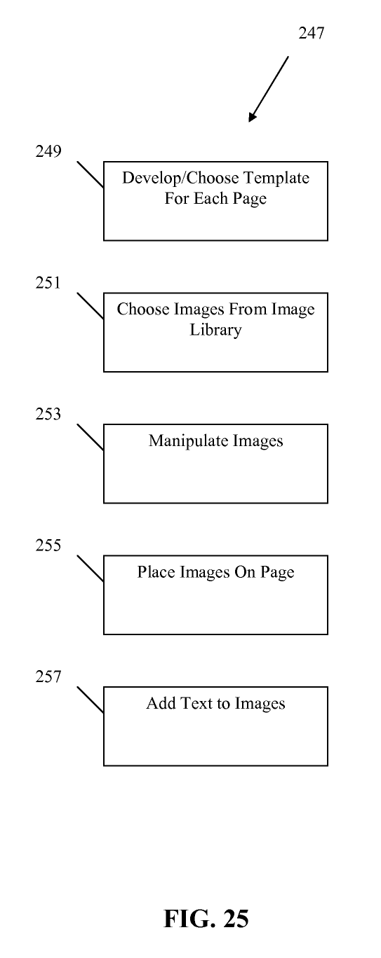

Each staff member then may take control of their assigned pages. FIG. 25 illustrates a process flow 247 of a staff member customizing a page in accordance with one embodiment of the present invention. The staff member may develop or choose a template for each of their pages 249. In other embodiments, these types of content may be chosen or modified during customization of the page. After a template has been associated with the page, the staff member can customize the page with content. Customization of the page, or page creation, may be done using a designer provided on the System. The designer may incorporate elements of desktop publishing as well as customization elements of the System. The designer generally permits manipulation of the page in a user-friendly manner.

Content placed on the page may automatically take on the visual elements associated with that page, for example by the template of the page. For example, visual elements associated with the template may include font type, size, and color for text. Thus, any text added to the page may have that font type, size, and color. In some embodiments, to change the visual elements, the change must be universal to the page. In other embodiments, a user may change visual elements associated with a single portion, or generally less than all of the portions, of the page. In an alternative embodiment, the user may further enter desired visual elements such as colors, fonts, illustrations, covers, and other visual elements. These desired visual elements may then be incorporated into the page.

Customizing the page with content may include choosing images from the image library 251, manipulating the images 253, and placing the images on the page 255. Manipulating the images may include, for example, colorizing the images, cropping the images, or otherwise using the image manipulation tools provided with the system.

In some embodiments, the System may facilitate adding further image boxes to a template or page. The staff member can select a shape for the image box, a border for the image box, or other. The staff member can size, rotate, or move the image box. After placement of the image box, the staff member can place an image from the Image Library into the image box. The image can be rotated, cropped, panned, have advanced styling features applied, or otherwise edited.

Customizing the page with content may further include adding text to the page 257. Adding text may be done by adding a text box and flowing text into the text box. In some embodiments, the text box may be designated as having one or more columns and the text may automatically flow in such columns. In some embodiments, the text may be designated on a path such that the text wraps around and image or element. In various embodiments, the System displays fonts and other elements of the page in the chosen style on the designer. Thus, during creation, a staff member can assess the visual elements of the page without accessing the Virtual Book.

In some embodiments, the System may facilitate adding further text boxes to a template or page. The staff member can select a shape for the text box, a border for the text box, background or fill for the text box, or other. The staff member can specify font, color, matte, and size for the text. The staff member can size, rotate, or move the text box. After placement of the text box, the user can place content, such as a vignette or stats, into the text box. Spell check and an appropriateness filter may assist the user with text.

Various customization tools may be provided that may be used for images, text, or other content. Such tools may include the ability to drop shadow on images, text, or elements. Dropping shadow creates a shadow behind the image or element.

After, or during, customization of the page, the staff member may save the page. The System may enable viewing of a page history such that the staff member can access and restore previously saved versions of the page. In some embodiments, the System enables viewing and restoring of the last 1000 versions of the page.

The System may further enable access to staff member history. For example, a staff member or advisor may look at staff member history for another staff member to look at what pages the staff member has worked on, which images the staff member has uploaded, etc.

In some embodiments, the system includes functionality for students to create personalized yearbook pages that may be included in their yearbook. Such functionality may link to the Image Share site such that photos tagged with that student may be flowed into the personalized yearbook pages, manually or automatically. In addition, a version of the yearbook staff system may be provided to non-staff students such that they may customize their personalized pages with templates, text, pictures, etc.

In some embodiments, students can select the option of purchasing personal yearbook pages. This may be during check out or in an earlier screening of students interested in purchasing yearbooks, for example. Before or after electing to include personal yearbook pages in the student's yearbook, the student, parent, or other party may upload photos to the image share site, or a dedicated personal yearbook pages web site. The system may auto flow the images onto a selected number of personal yearbook pages, for example. The number of pages may range from approximately 1 to approximately 8 or from approximately 2 to approximately 6, or approximately 4 personal yearbook pages. After the photos are autoflowed, the student may view the pages and edit them if desired. Where students are not interested in uploading photos or where the student or students are slow to upload, the system may e-mail the student with an interne link to the system, where they can upload and auto flow or create 4 pages to be included only in their yearbook.

### Status Monitoring

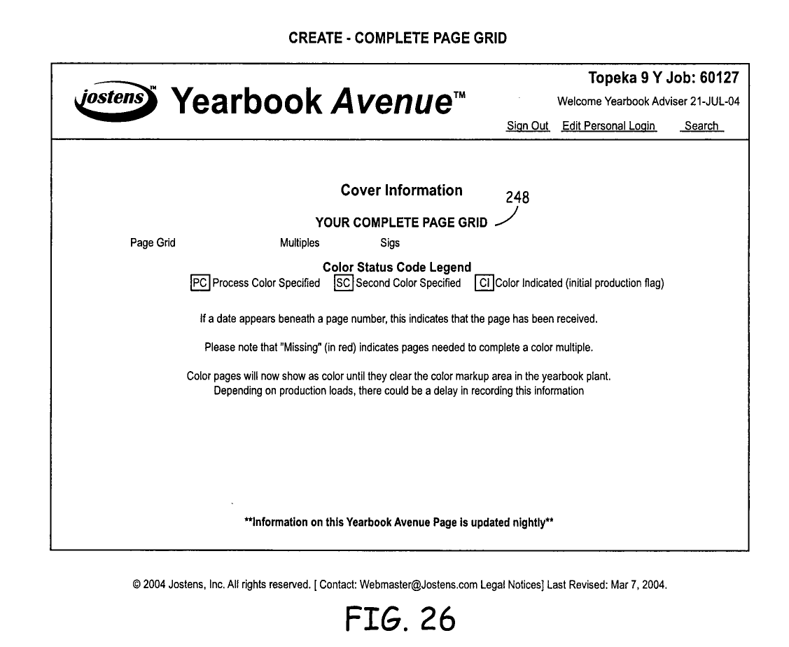

A Page Status Grid is illustrated at FIG. 26. The page status grid 248 includes information regarding the page grid, the multiples, and the signatures.

A Summary Report 250 is illustrated at FIG. 27. The summary report 250 may list the current book statistics 252, the yearbook options ordered 254, the yearbook cover information 256, the yearbook endsheet information 258, the page/photo submission deadlines 260, the page submissions received 262, the page submission totals 264, the key dates 266, the scheduled deposits 268, the payments received 270, the latest page submission message 272, and the complete page grid 274. A complete proof grid 276 with color coding may also be provided.

A current book statistics field 252 includes information regarding the number of pages, the book size, and the copies planned. A yearbook options field 254 indicates the yearbook options ordered. A yearbook cover information field 256 includes the kind of cover and the trim size. An endsheet information field 258 includes the front paper, the front color 1, the front color 2, the back paper, the back color 1, the back color 2, whether a special design was used, whether the front and back endsheets are the same, whether the endsheet has printing on the pages, whether the endsheet is being proofed, the date the proof was sent, and the date the proof was returned. A page/photo submission deadlines field 260 lists the deadline, the deadline date, the pages required, the photos required, the photos needed, the pages assigned in the ladder, and the deadline completion date. A page submissions received field 262 indicates what pages have been received and the date of receipt of the pages. A page submissions totals field 264 indicates the total number of pages received and the total number of pages needed. A key dates field 266 indicate key dates such as the contract ship date. A scheduled deposits field 268 indicates the deposit, the deposit due, the date due, the balance due, and the status. A payments received field 270 indicates the date and amount received. A latest submission message field 272 shows the latest submission message. A complete page grid field 274 lists the page grid, the multiples and the signatures. A color coded complete grid 276 provides a box for each page. The boxes may be color coded according to a color status code legend.

### Sell

The yearbook system home page 34 provides a Sell tab 44 for accessing Sell information. The Sell information includes information and tools useful for yearbook staff to market and sell the yearbook. Generally, the Sell information includes both school specific information and informational content. The informational content is typically dynamic. In some embodiments, the business manager staff member has responsibility for marketing, sales, collateral, budget, etc. That staff member may further have responsibility for managing funds associated with the yearbook. The yearbook system thus further may include content to facilitate the business manager staff member's fulfillment of these roles.

Selling features may be included with YBA email, described above. For example, email templates may be offered with the Sell information. Email address information may be flowed into the yearbook system such that emails may be sent from the YBA email to such emails.

In some embodiments, information may be accessed for facilitating sales of yearbooks. For example, student list data from previous years may be accessible to yearbook staff. When such data is available, email information may be linked to the yearbook staff such that emails may be targeted to previous purchasers of yearbooks. This may be cross functional with the YBA email.

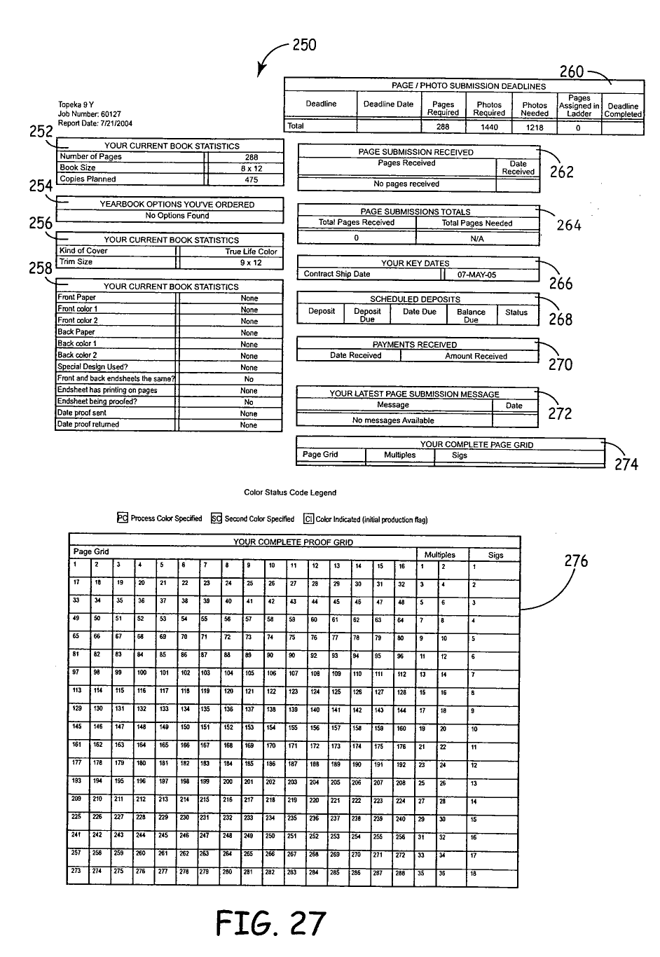

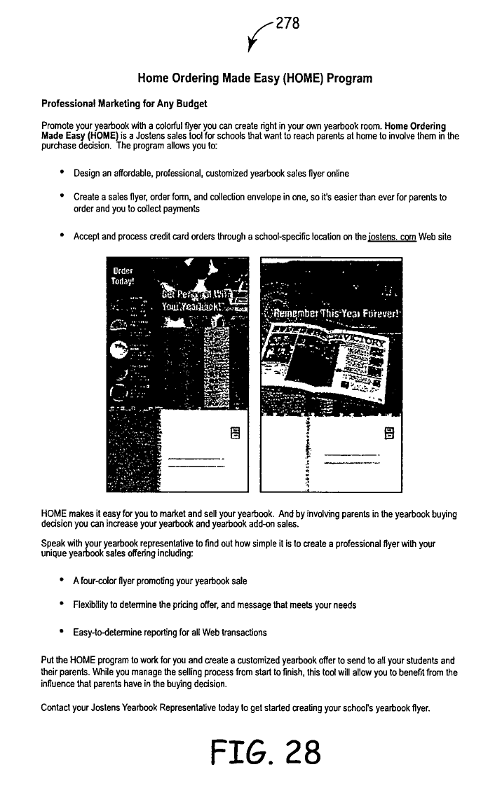

A HOME flyer page 278 is shown in FIG. 28. The HOME (Home Ordering Made Easy) program allows yearbook staff to promote their yearbook with a colorful flyer that can be custom created online. The HOME program is an optional tool that may be used by yearbook staff.

Information from the photo coverage and index pages may be used to incentivize particular parents or students to place orders. For example, if a particular student is identified as having not purchased a yearbook, a flyer may be printed including a page of the yearbook having a picture of that student. The flyer, thus, shows an example of where the student appears in the yearbook.

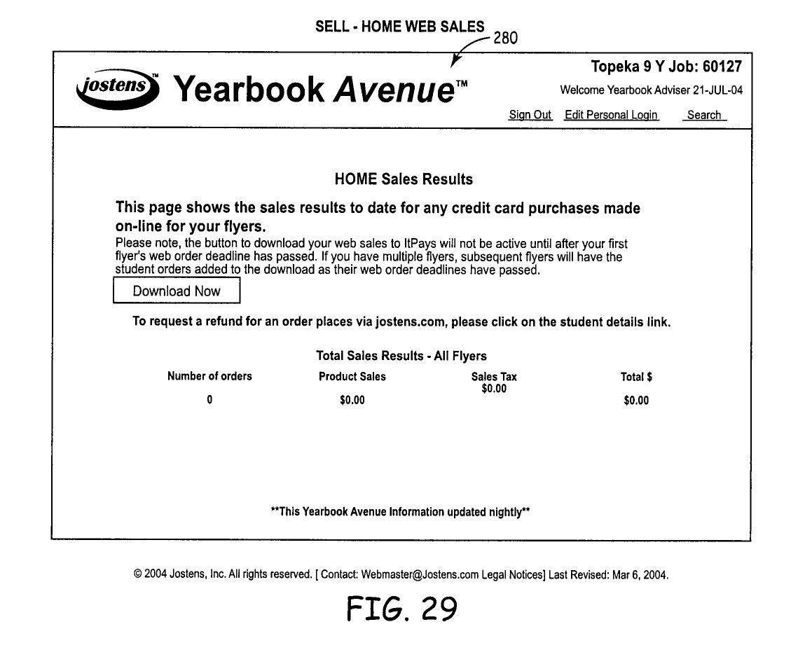

A HOME web sales page 280 may be associated with the HOME program and is shown in FIG. 29. The HOME web sales page 280 shows the HOME sales results to date for any credit card purchases made on-line for the flyers.

The yearbook system may, in some embodiments, include automated order forms accessible online or in print. The yearbook system further may provide the ability to sell a book and an advertisement jointly.

Example informational content in the Sell category includes software for processing payments, such as ItPays software.

In some embodiments, the System may generate PDFs of invoices for emailing to purchasers of the yearbook. Alternatively the System may automatically format an email invoice for emailing to purchasers of the yearbook.

### Distribute

The yearbook system home page 34 provides a Distribute tab 46 for accessing Distribute information. The Distribute information includes information and tools useful for yearbook staff to market and sell the yearbook. Generally, the Distribute information includes informational content. The informational content is typically dynamic.

The Distribute information includes tools for distribution. These tools are typically dynamic content and may be changed frequently. The distribute information may offer posters or promotional materials for display in the school.

Challenges with distribution often arise from yearbook options chosen by students—for example, a personalized yearbook or a yearbook with signature pages for signing.

### Help

The yearbook system home page 34 provides a Help tab 49 for accessing Help information for aiding users in using the yearbook system. Generally, the Help information includes informational content. The informational content is typically dynamic.

Example help pages provided within the Help information include a help screen regarding the yearbook system as a whole, a help screen regarding an online yearbook creation tool, a help screen regarding ItPays software, an interactive help screen, or a page with helpful links.

### Contact Us

The yearbook system home page 34 provides a Contact Us tab 51 for accessing Contact Us information. The Contact Us information includes information and tools useful for yearbook staff to contact a representative or production facility. Generally, the Contact Us information includes both school specific information and informational content. The informational content is typically dynamic.

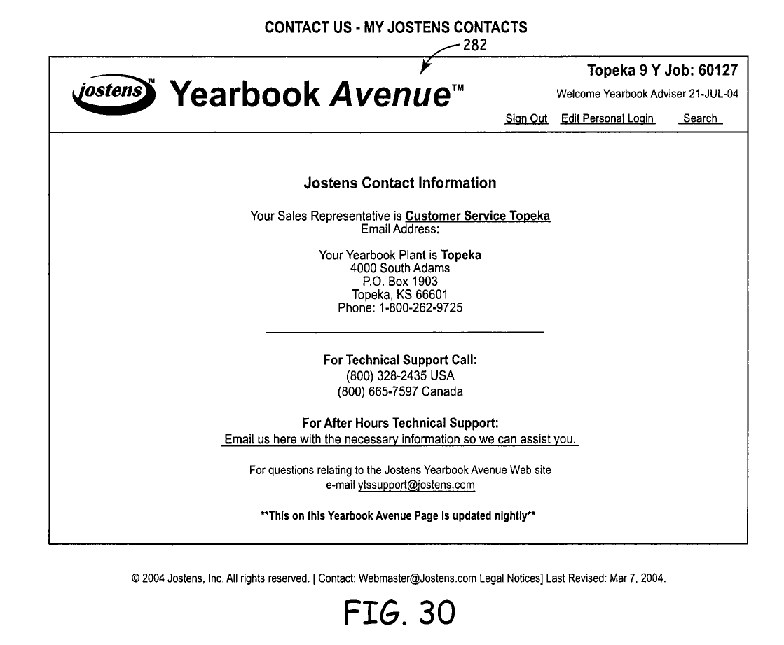

A contact information page 282 is shown in FIG. 30. The contact information page 282 may provide contact information for a yearbook system representative, for technical support, and for after hours technical support. By providing an easily accessible page having such information, yearbook staff may easily resolve questions or issues.

The Contact Us information may also provide a page for providing feedback regarding the yearbook system. Further, the Contact Us information may provide a page for accessing feedback regarding the yearbook system provided by others.

### Supplies

The yearbook system home page 34 provides a Supplies tab 53 for accessing Supplies information. The Supplies information includes supplies and ordering information for such supplies. The supplies may include, for example, generic posters or flyers advertising sales of the yearbook. Generally, the Supplies information includes both school specific information and informational content. The informational content is typically dynamic.

Thus, the yearbook system provides a tool for use by yearbook staff from the start to the finish of the yearbook process. The yearbook system may be used for educating yearbook staff regarding the yearbook process, for planning the yearbook, for creating the yearbook, for selling the yearbook (including merchandising), and for distributing the yearbook.

### Yearbook System Management and Production

The yearbook system management and production can be thought of as the back-end of the yearbook system. That is, the yearbook system management works with the schools during creation—storing input information, communicating with the school, etc. The production facility ultimately produces the yearbook.

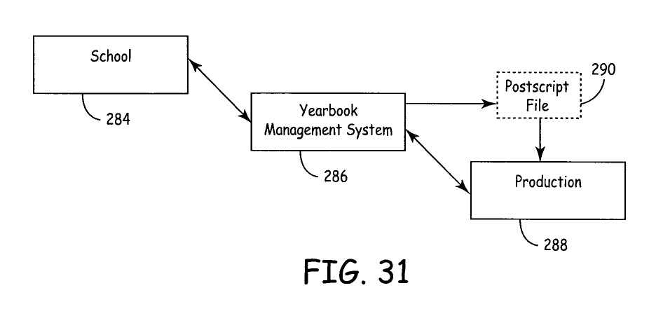

Seamless running of the yearbook system involves extensive communication between the yearbook staff, the yearbook system management, and the production facility. Thus, the yearbook system facilitates cross-communication at a detailed level. FIG. 31 illustrates the flow of communication between the school 284 or yearbook staff, the yearbook system management 286, and the production facility 288. The yearbook process spans several months—generally from the start of the school year until mid to late spring. If communication is not ongoing during the entire yearbook process, it may be very difficult to finalize the yearbook on time. For example, if deficiencies with submissions are not identified and address throughout the process and are, instead, identified and addressed only after all pages have been submitted, there may not be sufficient time for the staff to correct the deficiencies and still have the yearbook produced on schedule.

As shown in FIG. 31, generally there is extensive communication between the school 284 and the yearbook system management 286. This communication includes submissions by the school 284, for example photo submissions or page submissions and responses from the yearbook system management 286. For example, the school 284 (or other contributors such as parents) may submit physical photos to the production facility for scanning. The production facility 288 scans the photos. The photos are made available on a yearbook server at the yearbook system management 286. The yearbook system management 286 notifies the school 284 that the photos are available. Similarly, a school 284 may submit completed pages to the yearbook system management. The yearbook system management 286 acknowledges receipt of the submission. Once the page is submitted, all the information of the page is written into a postscript file 290 and sent to the production facility 288. A pdf file of the submitted page is made and reviewed by production facility. If there are deficiencies in the submission, the yearbook system management 286 notifies the school 284 so that the school 284 can correct the deficiencies and re-submit the page. The pdf pages will be further processed in the production facility and printed using appropriate out devices.

In some embodiments, a school may develop pages on a desktop publishing system and provide designed pages to the yearbook management system. The designed pages then may be printed and scanned in by the production facility and incorporated into a build ladder of the yearbook system. The build ladder may be provided online such that the school then may access the build ladder, view the virtual book, and use other tools of the yearbook management system.

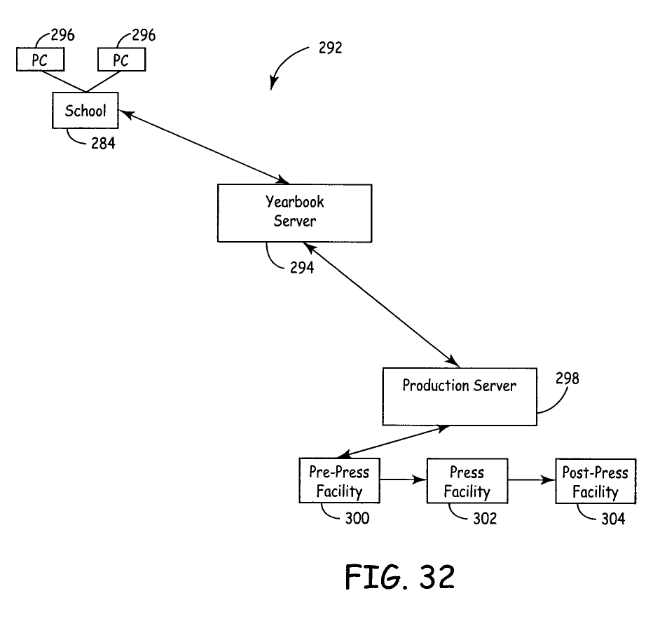

FIG. 32 illustrates a block diagram of the components of the yearbook system. The yearbook system 292 includes a yearbook server 294 at the yearbook system management. Users at the school 284 communicate with the yearbook server 294 via the internet using individual personal computers 296 (or other suitable device, for example, a PDA).

The yearbook server 294 includes and communicates with the personal computers 296 via the internet or other suitable connection, receiving user creation information, prompting users for further information when necessary, and transmitting information to the user. The yearbook server 294 further communicates with a production server 298 at the production facility to update the production Database 298 such that the yearbook database 294 and production database 298 are in sync. Note that each of the yearbook server 294 and the production server 298 may be database servers. The production facility may be several facilities including a pre-press facility 300, a press facility 302, and a post-press facility 304. Alternately, these several facilities may be provided in a single facility. The production server 298 periodically synchronizes with the yearbook server 294, for example, in providing specific customer images to the yearbook server.

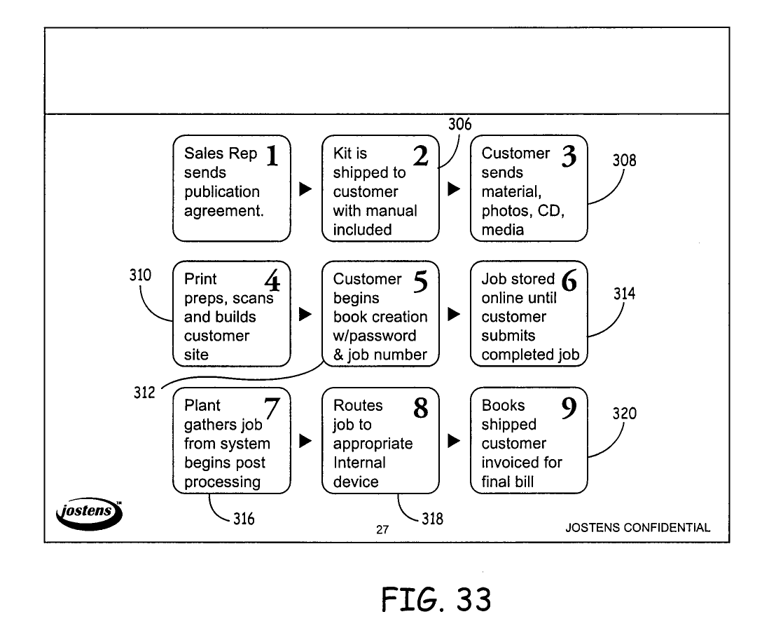

FIG. 33 is a block diagram of the overall process of creating a yearbook using the present invention. After the user has initiated the process, a kit is shipped to the user, shown at block 306. This kit may include a shipping carton, mounting sheets, photo sorting envelopes, an instruction manual, and a return shipping carton. While the creation of yearbooks in accordance with the present invention generally is online, there are portions of the yearbook creation that may deal with non-digital or non-electronic items. For example, not all photographs may be available in digital form. These photographs may be scanned in by the school or may be shipped to the pre-press production facility for scanning in. Thus, as shown at block 308, the user may send material, photos, CDs, and media to the pre-press production facility (anything sent by the user may be returned after processing). Shown at block 310, the pre-press production facility preps, scans and uploads the materials to the user site. Access to the user site may be username, password, and/or job number secured. The user creates the yearbook using the password and/or job number, as shown at block 312. The created pages are stored at the yearbook server until the user submits the completed page, shown at block 314. Once the user has submitted the completed page, the yearbook server gathers the page and transmits the page to a production server to begin post processing, shown at block 316. The production server routes portions of the job to the appropriate section of the production facility, shown at block 318, for example to the press facility for printing yearbook pages. After completed, the post-press facility ships the yearbooks to the user, shown at block 320.

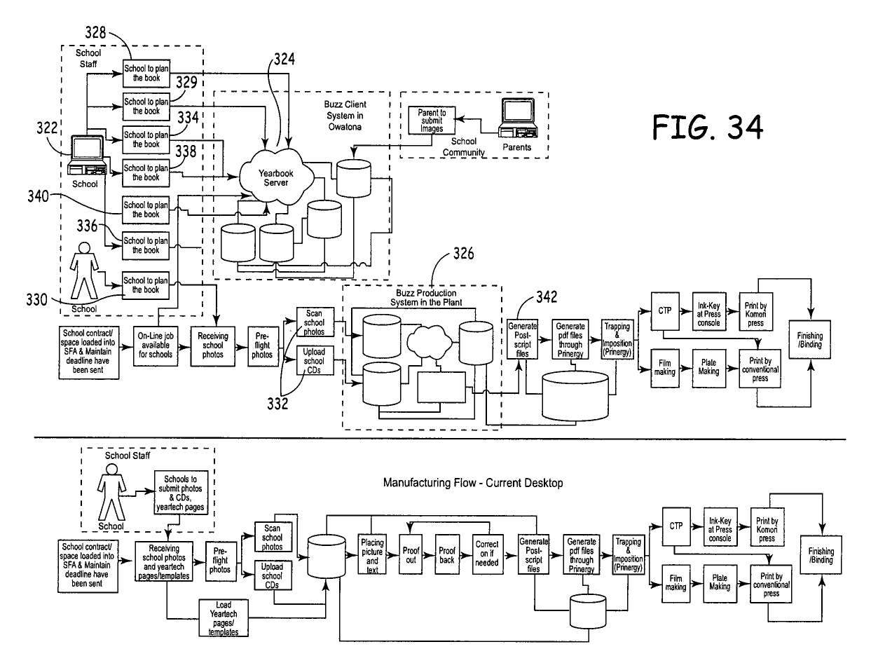

FIG. 34 illustrates a juxtaposition of the process of FIG. 33 on the components of FIG. 32. The school 322 plans the yearbook, shown at block 328, and uploads images, shown at block 329. Additionally, as shown at block 330, the school 322 may submit photos, CDs and other materials to the production facility 326. These images are scanned or uploaded by pre-press facility, shown at block 332, and transmitted as low resolution images to the yearbook server 324 for access by the school 322. Using an online creation system, the school 322 builds and submits pages, shown at blocks 334 and 336, to the yearbook server 324. The pages may be submitted from the build ladder or may be submitted directly from the designer. The school may selfproof pages on the screen, shown at block 338, and check page status online, shown at block 340. Once submitted, the pages are transmitted to the production server 326 as a postscript file, shown at block 342. The production server processes the pages for printing, for example, translating the submitted pages into a format for proceeding through the regular preparation for production of the yearbook, print them and finish the yearbooks.

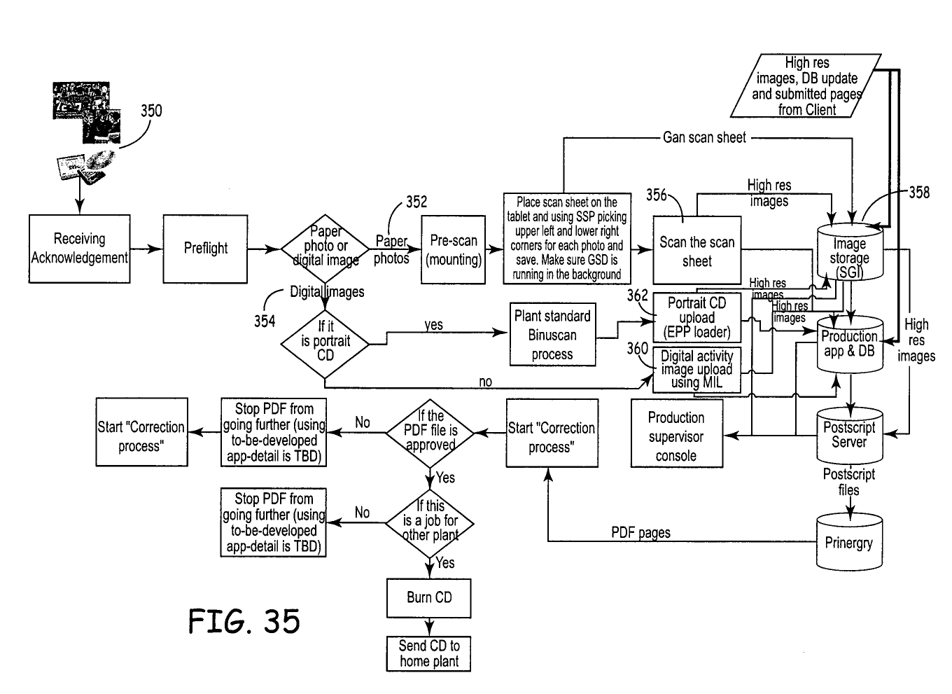

FIG. 35 illustrates a completed production operating process. Upon receipt of the materials 350 for scan and upload, the material is associated with a job number and category name. Typically, customer photos include activity photos and portrait photos and may be formatted as physical photos 352 or as digital images 354 on photo CDs. Physical photos are batch scanned 356 and disassembled into individual images and uploaded to production image storage 358 using production software to communicate with the production database. Activity photo CDs may be uploaded 360 to the production image storage 358 using suitable production software to communicate with the production server. Portrait CDs may be received from school photographers. Portrait CDs typically include portrait images associated with a student name list. The portrait images and student name list may be uploaded 362 to the production image storage 358 using suitable production software to communicate with the production database. Once the images are uploaded to the production image storage, a low resolution version of the images and thumbnails may be generated. Those low resolution images and thumbnails are synced to yearbook server for school use in yearbook creation. High resolution images stored in production image storage are used when the postscript file is generated.

The job may be archived for future access, for example for reprints. One suitable manner of archiving is to convert the “pages” created using the present invention into PDF files. The PDF files may then be archived on an archiving server or on media. Alternately, if desired, individual images may be archived.

While several of the features and options available in the above system have been described with respect to their functions, it is appreciated that each of the identified functionalities may be embodied in modules in the form of hardware or software or a combination of hardware and software. The modules may include computer implemented instructions stored in a computer readable storage medium and may thus, allow for performance of functions by a computing device. For example, the facial recognition features, or parts thereof, of the system may be provided by a facial recognition module. The coverage report features, or parts thereof, of the system may be provided by a coverage report module, for example. Other modules for other functionalities identified and described may also be provided.

Although the present invention has been described with reference to preferred embodiments, persons skilled in the art will recognize that changes may be made in form and detail without departing from the spirit and scope of the invention.

What is claimed is:

1. A yearbook system comprising:
a user component through which a user may design and create a yearbook, the user component comprising a facial recognition module for identifying a subject in a photo and tagging the photo with an identity of the subject, wherein identifying the subject includes comparing the photo to a plurality of previously tagged photos to identify the subject.

2. The system of claim 1, further comprising a photo submission website wherein the facial recognition module performs the identifying operation upon upload of the photo to the photo submission website.

3. The system of claim 1, wherein identifying a subject includes one or more of geometric and photometric processes.

4. The system of claim 1, wherein the plurality of previously tagged photos includes at least three previously tagged photos of the subject.

5. The system of claim 1, wherein the facial recognition module is further configured for prompting a user with a facial suggestion.

6. The system of claim 5, wherein prompting the user with the suggestion further comprises displaying a comparable image of the subject.

7. The system of claim 5, wherein prompting the user includes prompting the user to confirm or deny the identity.

8. The system of claim 5, wherein prompting the user includes prompting the user to manually enter a tag.

9. The system of claim 5, wherein prompting the user with a facial suggestion includes displaying a list of names and highlighting a name in the list of names.

10. The system of claim 9, wherein the list of names is a coverage report.

11. A method for creating a yearbook, comprising:
receiving a plurality of photos via upload to a website;
receiving identifying information for subjects in each of the plurality of photos;
associating the identifying information with each of the plurality of photos;
receiving another photo;
comparing the photo to the plurality of photos using a facial recognition module; and
identifying a subject of the another photo with the facial recognition module.

12. The method of claim 11, wherein identifying a subject includes one or more of geometric and photometric processes.

13. The method of claim 11, further comprising prompting the user with a facial suggestion.

14. The method of claim 13, wherein prompting the user with the suggestion further comprises displaying a comparable image of the subject.

15. The method of claim 14, wherein prompting the user includes prompting the user to confirm or deny the facial suggestion.

16. The method of claim 14, wherein prompting the user includes prompting the user to manually enter a tag.

17. The method of claim 14, wherein prompting the user with a facial suggestion includes displaying a list of names and highlighting a name in the list of names.

18. The system of claim 17, wherein the list of names is a coverage report.
